(19) United States
(12) Patent Application Publication
(10) Pub. No.: US 2008/0118573 A1
(43) Pub. Date: May 22, 2008

(54) Use of Heavy Metals in the Treatment of Biofilms

(76) Inventors: Joe Jonathan Harrison, Calgary (CA); Raymond Joseph Turner, Calgary (CA); Howard Ceri, Calgary (CA)

Correspondence Address: FULBRIGHT & JAWORSKI L.L.P., 600 CONGRESS AVE., SUITE 2400, AUSTIN, TX, 78701, US

(21) Appl. No.: 11/575,679

(22) PCT Filed: Jun. 21, 2005
(86) PCT No.: PCT/CA05/00974

§ 371 Date: Jan. 17, 2008

Related U.S. Application Data
(60) Provisional application No. 60/580,914, filed on Jun. 21, 2004.

(51) Int. Cl. A01N 59/16; A01N 59/18; A01N 59/20; A01N 59/06; A01P 3/00; A01P 1/00

(52) U.S. Cl. 424/618; 424/617; 424/639; 424/646; 424/630; 424/641; 424/682; 424/644; 424/652; 424/654; 424/650

(57) ABSTRACT

The present invention is directed to a method of treating biofilms by exposure to heavy metals selected from the group comprising metal cations such as manganese, cobalt, nickel, copper, zinc, aluminum, silver, mercury, lead, cadmium and tin; metal oxyanions such as molybdate, tungstate and chromate; and metalloid oxyanions, alone or in combination with antimicrobials. The present invention also includes compositions and methods for preparing or treating medical devices and medications.

### BACKGROUND OF THE INVENTION

1. Field of the Invention

The present invention is directed to biofilm and planktonic susceptibility to heavy metals, including but not limited to metals, metal cations, metal oxyanions, and metalloid oxyanions, alone or in combination with anti-microbials.

2. Description of Related Art

Biofilms are irregularly structured, surface-adherent microbial communities encased in a matrix of extracellular polymeric substance. Bacterial biofilms play a pivotal role in the chemical cycling of metals in the environment (Brown et al., 2003) and are known and to mediate the corrosion of pipelines and other metal surfaces (Hamilton, 2003). Biofilms are responsible for the majority of refractory bacterial infections encountered in dentistry and medicine (Costerton et al., 1999). The mature biofilm is notoriously difficult to eradicate relative to logarithmic-phase planktonic bacteria. Typically, biofilms present with a 10- to 100-fold increased tolerance to antibiotics (Ceri et al., 1999; Costerton et al., 1999; Olson et al., 2002), a demonstrable tolerance to biocides (Spoering and Lewis, 2001), and a reported 2- to 600-fold increased tolerance to the heavy metals Cu²⁺, Pb²⁺, and Zn²⁺ (Teitzel and Parsek, 2003).

The genetic mechanism of biofilm tolerance to antimicrobials is to date unknown, but has been hypothesized to involve growth-stage dependent production of specialized survivor cells termed “persisters” (Spoering and Lewis, 2001; Keren et al., 2004). Many other theories exist regarding the resistance capabilities of biofilms.

Our research group has recently reported that in rich growth media with 24 h exposure times, biofilm and planktonic cells of Escherichia coli, Staphylococcus aureus and Pseudomonas aeruginosa are equally susceptible to killing by metal cations and oxyanions (Harrison et al., 2004). These results are apparently contradictory to the established model of biofilm tolerance to antimicrobials.

In this report we used a high-throughput technique (the MBEC_{J}-HTP assay) for Harrison et al. (2004). The principle strength of this assay lies in the potential for a combinatorial experimental approach to rapidly screen diverse permutations of media, metals and exposure times. Using this assay, we designed our study to address the apparent incongruity existing between three recent observations: 1) the report by Harrison et al. (2004) that biofilms and planktonic cells of P. aeruginosa are equally susceptible to killing by metal cations with 24 h exposure (in rich media); 2) the report by Teitzel and Parsek (2003) that biofilms of P. aeruginosa are 2- to 600-times more resistant to divalent heavy metal cations than planktonic bacteria with 5 h exposure (in minimal media or MOPS buffered saline); and 3) the evolving model that persister cells may mediate, in part, the observed tolerance of biofilms and planktonic cells to microbicidal agents (Spoering and Lewis, 2001; Stewart, 2002; Keren et al., 2004). The data in the present study suggest that all three of these may be concordant.

Spoering and Lewis (2001 ) were the first to describe that stationary-phase cultures of Staphylococcus aureus, Pseudomonas aeruginosa and Escherichia coli, like biofilms, produce high levels of persisters (which account for 10⁻⁶ to 10⁻³ of the bacterial population), and that they consequently exhibit antibiotic tolerance comparable to that found in biofilms. This trend is not true of logarithmic-growing planktonic bacteria, which are well known to be many times more susceptible to bactericidal antibiotics than biofilms. Using the MBEC_{J}-HTP assay, P. aeruginosa ATCC 27853 biofilms have been observed to be up to 64 times more tolerant to antibiotics than corresponding logarithmic-growing planktonic cultures at 24 h exposure (Harrison et al., 2004). Even after 100 h of exposure and using alternate microbiological methods, the log₁₀ reduction in viable cell counts of P. aeruginosa biofilms by tobramycin and ciprofloxacin has been observed to be less than 0.5 and 1.5, respectively (Walters III et al., 2003). This is pointedly dissimilar with the time-dependent killing of P. aeruginosa biofilms by metal cations. Walters III et al. (2003) correlated antibiotic sensitivity to the differential metabolic activity of bacteria in aerobic and anoxic zones of the biofilm. Highly metabolic bacteria in oxic zones of the biofilm were observed to be more sensitive to antibiotics than slow-growing bacteria in anaerobic regions. Structure dependent metabolic heterogeneity in biofilms may still result in protected niches for a small part of the bacterial population to survive metal toxicity. However, in application, metal cations may still eradicate slow-growing bacteria as efficaciously as fast-growers given longer exposure times. In this regard, metal cations and antibiotics have different and distinct long term activities against bacterial biofilms.

Biofilms are infamous for their ability to withstand antimicrobials. However, it is erroneous to label biofilms as “resistant” since they do not grow at high concentrations of these compounds. Rather, biofilms may be considered highly “tolerant” to microbicidal agents because they do not die. Persisters are known to survive high levels of antibiotics for prolonged exposure times.

Ecologically, metal compounds are disseminated in our environment through volcanic, meteorological and anthropogenic activities. Human activity and pollution are a particular concern, as industrial effluent and mine drainage run off create contaminated environmental niches that select for and increase the persistence of bacterial metal resistance determinants (Silver, 1998; Turner, 2001). Bacteria have developed a diverse array of strategies to counter heavy metal toxicity. These strategies include reduction or modification of the heavy metal to a less toxic species, sequestration, chelation, efflux, reduced uptake, and increased expression of cellular repair machinery (Silver, 1998; Nies, 1999; Turner, 2001). Previous studies of biofilm and heavy metal interactions have focused on bioremediation of soil, sediment and wastewater (Valls and de Lorenzo, 2002; Codony et al., 2003), and in application to biological mining of ore (Rawlings, 2002).

Heavy metals have historically had a role as antimicrobials and disinfectants, but only recently have medicine and industry begun to examine these compounds for activity against biofilms. Currently, effective biofilm eradication is one of the biggest challenges to the development of antimicrobial agents and chemotherapies. Although it has been well documented that biofilm bacteria present with a 10- to 100-fold increased tolerance to antibiotics, only one study to date has specifically examined heavy metal resistance in the bacterial biofilm (Teitzel and Parsek, 2003). Teitzel and Parsek (2003) reported that in minimal media with short exposure times, biofilms have a demonstrable resistance to the heavy metals Cu²⁺, Zn²⁺, and Pb²⁺.

### SUMMARY OF THE INVENTION

In this study, we examined Pseudomonas aeruginosa ATCC 27853 biofilm and planktonic cell susceptibility to metal cations. The minimum inhibitory concentration (MIC), the minimum bactericidal concentration required to eradicate 100% of the planktonic population (MBC₁₀₀), and the minimum biofilm eradication concentration (MBEC) were determined using the MBEC_{J}-high throughput (HTP) assay. Six metals—Co²⁺, Ni²⁺, Cu²⁺, Zn²⁺, Al³⁺, and Pb²⁺—were each tested at 2, 4, 6, 8, 10 and 27 hours of exposure to biofilm and planktonic cultures grown in rich or minimal media. With 2 or 4 hours of exposure, biofilms were approximately 2 to 25 times more tolerant to killing by metal cations than the corresponding planktonic cultures. However, by 27 hours of exposure, biofilm and planktonic bacteria were killed at approximately the same concentration in every instance. Viable cell counts evaluated at 2 and 27 hours of exposure revealed that at high concentrations, most of the metals assayed had killed greater than 99.9% of biofilm and planktonic cell populations. The observed survival of 0.1% or less of the bacterial population corresponds well with the hypothesis that a small population of “persister” cells may be largely responsible for the tolerance of both planktonic cells and biofilms to metals. Our data suggest that bacterial growth in a biofilm is not a mechanism of resistance to metal toxicity, but rather a time-dependent mechanism of tolerance.

Despite the ubiquitous distribution of metals and the recognition that biofilms are the predominant form of bacteria in nature, there is no previous report specifically examining the mechanism of biofilm susceptibility and tolerance to metal exposure.

We observed that in either rich or minimal media, the concentration of metal cations required to kill a biofilm decreased with exposure time. Eventually, with long enough exposure, biofilms were eradicated at approximately the same concentration required to eradicate logarithmic-growing planktonic bacteria. In general, at high concentrations of metal cations, 99.9% of both planktonic and biofilm bacterial populations were killed. Remarkably, the short term tolerance of biofilms to concentrations of metal cations greater than the planktonic minimum bactericidal concentration (MBC₁₀₀) was mediated by the survival of less than 0.1% of the bacterial population. There are two potential explanations for this phenomenon: 1) that persister cells in a biofilm are killed at a reduced rate by metal cations relative to the planktonic persister population, or 2) that there is a greater population of persisters in a biofilm that are killed at the same rate as planktonic persister cells.

Accordingly, a model based on the available data suggests that bacterial growth in a biofilm provides a time-dependent mechanism of tolerance to metal toxicity. In this model, persister cells may represent a protected, quiescent subpopulation that mediate (at least in part) the short term tolerance of the biofilm to very high concentrations of metal cations. This model does not refute that biofilm tolerance to metal cations may occur at multiple levels. Our data are consistent with the “restricted-penetration” hypothesis (Lewis, 2001) and may putatively represent a reaction-diffusion phenomenon (Stewart, 2003).

As it pertains to our model system and P. aeruginosa ATCC 27853, the data in our study suggest that this is not true for metal cations. In this study, we observed that 0.1% or less of the biofilm population survived for short periods of time at concentrations of metal cations in excess of the concentration required to eradicate planktonic bacteria (MBC₁₀₀). Persister cells may mediate a high level of tolerance to metal toxicity in both biofilm and planktonic cultures. However, in biofilms, persisters may only survive concentrations of metal cations in excess of the planktonic minimum bactericidal concentration for a finite period of time. We propose that the rate at which persisters die in biofilms upon exposure to metal cations may be decreased relative to the planktonic persister cell population. This implies that bacterial growth in a biofilm may be a time-dependent mechanism of tolerance to metal toxicity.

The accompanying drawings show illustrative embodiments of the invention from which these and other of the objectives, novel features and advantages will be readily apparent.

### DESCRIPTION OF THE DRAWINGS

FIG. 1 shows the killing of Pseudomonas aeruginosa ATCC 27853 cell populations by representative heavy metals from groups 8B and 1B of the periodic table.

FIG. 2 shows the killing of Pseudomonas aeruginosa ATCC 27853 cell populations by representative metals from groups 2B to 4A of the periodic table.

### DETAILED DESCRIPTION OF THE INVENTION

The present invention is a method of treating biofilms by contacting the biofilm with a composition comprising a heavy metal, and exposing the biofilm to the heavy metal for greater than about four hours. The biofilm may be any of a wide assortment of microorganisms, including but not limited to gram-positive bacteria, gram-negative bacteria, fungi, algae, and archaebacteria. The heavy metals may be any metal in Groups 4through 8 of the periodic table, ions thereof, anions thereof, or compounds containing a heavy metal. In accordance with the present invention, the biofilm should be exposed to the heavy metal for greater than about four hours, preferably greater than about eight hours, and most preferably greater than about 20 hours.

The present invention is also a composition for treating a biofilm, the composition including a heavy metal. In other embodiments of the invention, the composition may also include one or more second heavy metals, one or more biocides, one or more polycides, and/or one of more agents active against a biofilm or microorganism.

The methods and compositions of the present invention may also include incorporating an anti-microbial in the treatment protocol. Typical anti-microbials include, but are not limited to antibiotics, biocides, anti-fungals, and the like.

The present invention also includes compositions and methods for preparing, treating, or producing human and animal medical devices and medications; various plant and animal uses and environments described in more detail below; and in various industrial uses and environments described in more detail below.

As used herein, biofilm refers to biological films that develop and persist at interfaces in aqueous environments (Geesey, et al., Can. J. Microbiol. 32. 1733-6, 1977; 1994; Boivin and Costerton, Elsevier Appl. Sci., London, 53-62, 1991; Khoury, et al., ASAIO, 38, M174-178, 1992; Costerton, et al., J. Bacteriol., 176, 2137-2142, 1994), especially along the inner walls of conduit material in industrial facilities, in household plumbing systems, on medical implants, or as foci of chronic infections. These biological films are composed of microorganisms embedded in an organic gelatinous structure composed of one or more matrix polymers which are secreted by the resident microorganisms. Biofilms can develop into macroscopic structures several millimeters or centimeters in thickness and can cover large surface areas. These biological formations can play a role in restricting or entirely blocking flow in plumbing systems and often decrease the life of materials through corrosive action mediated by the embedded bacteria. Biofilms are also capable of trapping nutrients and particulates that can contribute to their enhanced development and stability.

A biofilm is a conglomerate of microbial organisms embedded in a highly hydrated matrix of exopolymers, typically polysaccharides, and other macromolecules (Costerton 1981). Biofilms may contain either single or multiple microbial species and readily adhere to such diverse surfaces as river rocks, soil, pipelines, teeth, mucous membranes, and medical implants (Costerton, 1987). By some estimates biofilm-associated cells outnumber planktonic cells of the same species by a ratio of 1000-10,000:1 in some environments.

The term “bacteria” encompasses many bacterial strains including gram negative bacteria and gram positive bacteria. Examples of gram negative bacteria include: Acinebacter; Aeromonas; Alcaligenes; Chromobacterium; Citrobacter; Enterobacter; Escherichia; Flavobacterium; Klebsiella; Moraxella; Morganella; Plesiomonas; Proteus; Pseudomonas; Salmonella; Serratia; and Xanthomonas. Examples of gram positive bacteria include: Arthrobacter; Bacillus; Micrococcus; Mycobacteria; Sarcina; Staphylococcus; and Streptococcus. Many of the aforementioned bacterial strains, such as Acinebacter; Aeromonas; Alcaligenes; Arthrobacter; Bacillus; Chromobacterium; Flavobacterium; Micrococcus; Moraxella; Mycobacteria; Plesiomonas; Proteus; Pseudomonas; Sarcina and others, are further referred to as heterotrophic bacteria, as they are extremely hardy and can readily grow in nutrient-poor water. The hydrogenotrophic bacteria preferably comprise one or more species of bacteria selected from the group consisting of Acetobacterium spp., Achromobacter spp., Aeromonas spp., Acinetobacter spp., Aureobacterium spp., Bacillus spp., Comamonas spp., Dehalobacter spp., Dehalospirillum spp., Dehalococcoide spp., Desulfurosarcina spp., Desulfomonile spp., Desulfobacterium spp., Enterobacter spp., Hydrogenobacter spp., Methanosarcina spp., Pseudomonas spp., Shewanella spp., Methanosarcina spp., Micrococcus spp., and Paracoccus spp.

As used herein, heavy metal is used in its conventional sense, referring to elements and compounds from Group 4 through 8 of the Periodic Table. Heavy metals includes, but is not limited to silver (including nanocrystalline silver), cobalt, copper, iron, lead, gold, silver, mercury, nickel, zinc, aluminum, stannous, tin, manganese, and platinum. The present invention also includes heavy metals ions and compounds.

As used herein, an exposure period or similar terms or concepts refers to the period of time required or found beneficial to reduce or eliminate a biofilm. In accordance with some embodiments of the invention, the period can be almost instantaneous, e.g., in a matter of seconds or minutes. In other embodiments of the invention, the period may be longer. For example, with some heavy metals, there is little or no biofilm eradication in the first four hours or so. In accordance with the invention, periods of up to about 36 hours or more may be required to eradicate a biofilm. Typically, the period is greater than about four hours, preferably between about fours hours and about thirty six hours, more preferably between about 10 to 30 hours. It should be understood that any incremental time period, e.g., fractions of a minute or an hour, are included within the definition of exposure period.

Among the antibiotics which are useful in the present invention are those in the penicillin, cephalosporin, aminoglycoside, tetracycline, sulfonamide, macrolide antibiotics, and quinoline antibiotic families. Preferred antibiotics also include imipenem, aztreonam, chloramphenicol, erythromycin, clindamycin, spectinomycin, vancomycin, and bacitracin. Among the preferred anti-fungal agents are the imidazole compounds, such as ketoconazole, and the polyene microlide antibiotic compounds, such as amphotericin B.

A wide variety of biocides that are capable of killing planktonic microorganisms are cited in the literature; see, for example, U.S. Pat. No. 4,297,224. They include the oxidizing biocides: chlorine, bromine, chlorine dioxide, chloroisocyanurates and halogen-containing hydantoins. They also include the non-oxidizing biocides: quaternary ammonium compounds, isothiazolones, aldehydes, parabens and organo-sulfur compounds.

Many antifungal agents are known to those of skill in the art and may be useful in the present invention. For example, antifungal agents contemplated for use in the present invention include, but are not limited to, new third generation triazoles such as UK 109,496 (Voriconazole); SCH 56592; ER30346; UK 9746; UK 9751; T 8581; and Flutrimazole; cell wall active cyclic lipopeptides such as Cilofungin LY121019; LY303366 (Echinocandin); and L-743872 (Pneumocandin); allylamines such as Terbinafine; imidazoles such as Omoconazole, Ketoconazole, Terconazole, Econazole, Itraconazole and Fluconazole; polyenes such as Amphotericin B, Nystatin, Natamycin, Liposomal Amphotericin B, and Liposomal Nystatin; and other antifungal agents including Griseofulvin; BF-796; MTCH 24; BTG-137586; RMP-7/Amphotericin B; Pradimicins (MNS 18184); Benanomicin; Ambisome; ABLC; ABCD; Nikkomycin Z; and Flucytosine.

Because biofouling is caused by various organisms including algae, bacteria, protozoans, and the like, other types of antibiotics may also be added to the chelator/antifungal compositions described above. Such agents may include, but are not limited to aminoglycoside, ampicillin, carbenicillin, cefazolin, cephalosporin, chloramphenicol, clindamycin, erythromycin, everninomycin, gentamycin, kanamycin, lipopeptides, methicillin, nafcillin, novobiocia, oxazolidinones, penicillin, polymyxin, quinolones, rifampin, streptogramins, streptomycin, sulfamethoxazole, sulfonamide, tetracycline, trimethoprim and vancomycin.

The antibiotics of the present invention may be delivered to an aqueous system at a dosage ranging from about 0.01 parts per million (ppm) to about 1000 ppm, more preferably at a dosage ranging from about 0.1 ppm to about 100 ppm, and most preferably at a dosage ranging from about 0.5 ppm to about 10 ppm, including all intermediate dosages therebetween.

Other active agents may include additional algicides, fungicides, corrosion inhibitors, scale inhibitors, complexing agents, surfactants, enzymes, nonoxidizing biocides and other compatible products which will lend greater functionality to the product. The other active agents of the present invention may be delivered to an aqueous system at a dosage known by those skilled in the art to be efficacious.

Other biocides that may be used are: ortho-phthalaldehyde, bromine, chlorine, ozone, chlorine dioxide, chlorhexidine, chloroisocyanurates, chlorine donors, formaldehyde, glutaraldehyde, halogen-containing hydantoins, a peroxy salt (a salt which produces hydrogen peroxide in water), a percarbonate, peracetate, persulfate, peroxide, or perborate salt, quaternary ammonium compounds, isothiazolones, parabens, silver sulfonamides, and organo-sulfur compounds. The other biocides of the present invention may be delivered to an aqueous system at a dosage known by those skilled in the art to be efficacious.

As used herein, the term “fungicidal” is defined to mean having a destructive killing action upon fungi. As used herein, the term “fungistatic” is defined to mean having an inhibiting action upon the growth of fungi.

For the purposes of this disclosure, the phrase “an antibacterial agent” denotes one or more antibacterial agents. As used herein, the term “antibacterial agent” is defined as a compound having either a bactericidal or bacteristatic effect upon bacteria contacted by the compound.

As used herein, the term “bactericidal” is defined to mean having a destructive killing action upon bacteria As used herein, the term “bacteristatic” is defined to mean having an inhibiting action upon the growth of bacteria.

For the purposes of this disclosure, the phrase “an antimicrobial agent” denotes one or more antimicrobial agents. As used herein, the term “antimicrobial agent” is defined as a compound having either a microbicidal or microbistatic effect upon microbes or microorganisms contacted by the compound.

As used herein, the term “microbicidal” is defined to mean having a destructive killing action upon microbes or microorganisms. As used herein, the term “microbistatic” is defined to mean having an inhibiting action upon the growth of microbes or microorganisms.

As used herein the terms “microbe” or “microorganism” are defined as very minute, microscopic life forms or organisms, which may be either plant or animal, and which may include, but are not limited to, algae, bacteria, and fungi.

As used herein the terms “contact”, “contacted”, and “contacting”, are used to describe the process by which an antimicrobial agent, e.g., any of the compositions disclosed in the present invention, comes in direct juxtaposition with the target microbe colony.

As used herein, the minimum bactericidal concentration (MBC) is conventionally defined as a concentration of an antimicrobial agent that kills 3 log₁₀ cells of a bacterial culture (or 99.9% of the bacteria). This definition is inadequate for examining the survival of less than 0.1% of the bacterial population. In this study, we will define the MBC₁₀₀ and MBEC as the concentration of metal ions required to eradicate 100% of the planktonic and biofilm bacterial populations, respectively. We will use the term “killing” to denote the death of any portion of the bacterial population of less than 100%, and the term “eradication” will be used to denote complete destruction of the bacterial culture (ie. 100% kill and thus no recoverable viable cells).

The term “aqueous system” includes, but is not necessarily limited to recreational systems, industrial systems, and aqueous base drilling systems. Suitable industrial systems include, but are not necessarily limited to cooling water systems used in power-generating plants, refineries, chemical plants, air conditioning systems, process systems used to manufacture pulp, paper, paperboard, and textiles, particularly water laid nonwoven fabrics.

Cooling water systems used in power-generating plants, refineries, chemical plants, air conditioning systems and other commercial and industrial operations frequently encounter biofilm problems. This is because cooling water systems are commonly contaminated with airborne organisms entrained by air/water contact in cooling towers, as well as waterborne organisms from the systems' makeup water supply. The water in such systems is generally an excellent growth medium for these organisms. If not controlled, the biofilm biofouling resulting from such growth can plug towers, block pipelines and coat heat transfer surfaces with layers of slime, and thereby prevent proper operation and reduce equipment efficiency. Furthermore, significant increases in frictional resistance to the flow of fluids through conduits affected by biofouling results in higher energy requirements to pump these fluids. In secondary oil recovery, which involves water flooding of the oil-containing formation, biofilms can plug the oil-bearing formation.

### EXAMPLES

### Example 1

### Bacterial Strains and Media

Pseudomonas aeruginosa ATCC 27853 was stored at −70₁C in a Microbank_{J} (Pro-Lab Diagnostics)—a commercially prepared sterile vial containing porous beads and cryopreservant. P. aeruginosa was grown in either Luria-Bertani media (pH 7.1, 5 g NaCl, 5 g yeast extract, and 10 g tryptone per liter of double distilled water) enriched with 0.01% w/v vitamin B1 (LB+B1), or minimal salts vitamins pyruvate (MSVP). MSVP was adapted from the formulation of Teitzel and Parsek (2003), and contained per liter of double distilled water 1.0 g (NH₄)₂SO₄, 30 mg MgSO₄, 60 mg CaCl₂, 20 mg KH₂PO₄, 15 mg Na₂HPO₄, 6.0 g pyruvic acid, 2.1 g MOPS, 1 ml of a 10 mM solution of MnSO₄, 1 ml of a 10 mM solution of FeSO₄, and 1 ml of a trace vitamin solution. MSVP media was adjusted to pH 7.1 with NaOH. The trace vitamin solution contained per liter of double distilled water 20 mg (+)-d-biotin, 20 mg folic acid, 50 mg thiamine hydrochloride, 50 mg d-calcium-pantothenate, 1 mg cyanocobalamin, 50 mg riboflavin, 50 mg nicotinic acid, 100 mg pyridoxine hydrochloride, and 50 mg p-aminobenzoic acid. Subcultures, MBC₁₀₀, and MBEC viable cell counts were performed on plates containing LB+B1 media with 1.5% w/v granulated agar. Susceptibility testing at 2 and 27 h of exposure was performed in both LB+B1 and MSVP. Exposure-time assays for all metal cations were performed in MSVP to minimize precipitation of the metal from solution.

### Biofilm Formation

Biofilms were formed in the MBEC_{J}-high throughput (HTP) device (MBEC Bioproducts Inc., Edmonton, Alberta, Canada, http://www.mbec.ca) using the manufacturer's instructions and as previously described (Ceri et al., 1999; Ceri et al., 2001). Briefly, the MBEC_{J} device consists of a plastic trough that houses a lid with 96 plastic pegs. The peg lid fits over a standard 96-well microtitre plate that can be subsequently used to set up serial dilutions of antimicrobials. In our experiments, the trough was inoculated with approximately 1×10⁷ bacteria suspended in 22 ml of the appropriate growth media. Subsequently, the MBEC_{J} device was placed on a rocking table (Red Rocker model, Hoefer Instrument Co.) in an incubator at 35₁C and 95% relative humidity. P. aeruginosa ATCC 27853 was incubated for 9.5 h in LB+B1 and 22 h in MSVP to form biofilms of approximately 6.0×10⁶ and 1.0×10⁶ cfu/peg, respectively. Following incubation, the growth of biofilm and planktonic cultures in the MBEC_{J} device were verified by viable cell counts. Biofilms were disrupted from pegs broken from the lid (using flamed pliers) or from all pegs at once, by sonication for 5 minutes on high using a waterbath sonicator (Aquasonic model 250HT, VWR Scientific) as previously described (Ceri et al., 1999; Ceri et al., 2001). As a quality control, viable cell counts were determined for biofilms formed on all of the pegs in rich media. Consistent with previous results (Ceri et al., 1999; Ceri et al., 2001), one-way ANOVA demonstrated that biofilm formation was statistically equivalent between the rows of different pegs (data not shown).

### Stock Metal Solutions

Aluminum sulphate (Al₂SO₄.18H₂O, Fisher Scientific), zinc sulphate (ZnSO₄.7H₂O, BDH Inc.), cupric sulphate (CuSO₄.5H₂O, Fisher Scientific), nickel sulphate (NiSO₄.6H₂O, Sigma-Aldrich Co.), lead nitrate (Pb(NO₃)₂, Sigma-Aldrich Co.), and cobalt (II) chloride (CoCl₂.6H₂O) were made up to concentrations of 40 mg/ml of the metal cation in double distilled water. The solutions were syringe filtered at 0.22 μm and stored at 20° 0 C. in sterile glass vials. Reagent grade metals were purchased for use in this study to eliminate the putative effects of other contaminating, residual metals on the outcome of the MIC, MBC₁₀₀ and MBEC determinations. Working solutions of 8192 μg/ml of the metal cations were prepared in LB+B1 or MSVP no more than 60 minutes prior to biofilm exposure. From these solutions, serial two-fold dilutions were made in the appropriate media along the wells of a sterile 96-well microtitre plate (the “challenge plate”), leaving the first row as a sterility control and the last row as growth control (i.e., no metal).

### Neutralizing Regime and Stock Neutralizing Agents

To differentiate between the bacteriostatic and bactericidal effects of the metal cations, a neutralization regime was employed to reduce the carry-over of biologically available metals from the challenge plate to the recovery media. The rationale used here was to reduce the amount of biologically available metal to a concentration below the MIC for P. aeruginosa. It is important to note that many neutralizing agents are toxic to bacterial cells at high concentrations. Thus, two mechanisms were employed here to reduce carry over: 1) the use of an appropriate neutralizing compound, and 2) the diffusion, complexation and precipitation of the metal within the rich agar media used for recovery.

Glutathione, a tripeptide that acts a reduction-oxidation buffer in the bacterial cell (Taylor, 1999; Turner et al., 1999), can covalently react with Zn²⁺, Co²⁺, and Pb²⁺ through reduction of a hilo group on a cytokine residue. Thus, 5 mM reduced GASH (Sigma-Aldrich Co.) was used as a neutralizing agent in Zn²⁺, Co²⁺, and Pb²⁺ assays. Cu²⁺ and Ni²⁺ were neutralized using the bidentate chelator diethyldithiocarbamate (DDTC, Sigam-Aldrich Co.) (Gottofrey et al., 1988; Agar et al., 1991). Although an efficacious neutralizing agent, DDTC is inhibitory to bacterial growth, which dictated the maximal concentration of 2.5 mM used in these assays. Incubation times were doubled for assays involving the use of DDTC. Finally, Al³⁺ was chelated using 1-2 mM 5-sulfosalicylic acid (Sigma-Aldrich Co.) (Graff et al., 1995). The toxicity of 5-sulfosalicylic acid limited the maximum concentration used here.

Stock solutions of GSH (0.25 M), DDTC (0.25 M), and 5-sulfosalicylic acid (0.25 M), were prepared in double distilled water, syringe filtered at 0.22 μm, and stored at −20° C. until use. Neutralizing agents were added directly to the recovery media or prepared at 5 times (5×) the desired concentration in 0.9% saline. The 5× stock solutions were added in 10 μl aliquots to each well of a sterile 96-well microtitre plate (the “neutralizing plate”). For rapid determination of MBC values in the exposure time assays and for viable cell counts of planktonic cultures, 40 μl aliquots from each well of the challenge plate were added to the corresponding well of the neutralizing plate. For the rapid determination of MBEC values used in the exposure time assays, biofilms were disrupted by sonication into LB+B1 containing the desired concentration of neutralizing agent (the “recovery plate”). For viable cell counts of biofilm cultures, first the biofilms on the peg lid were disrupted by sonication into a 96-well microtitre plate containing 200 μl of 0.9% saline. Subsequently, 40 μl aliquots were transferred from each well into a separate neutralizing plate. In all assays, the final concentration of neutralization agent used to treat planktonic and biofilm cultures was equal.

### Example 2

### Biofilm and Planktonic Culture Susceptibility Testing

Metal Cations and Oxyanions

Susceptibility testing was performed according to the method of Harrison et al. (2004). Biofilms formed on the lid of the MBEC_{J} device were washed once with 0.9% saline to remove adherent planktonic bacteria. The peg lids were then transferred to “challenge plates”, which were incubated at 35° C. and 95% relative humidity for 2, 4, 6, 8, 10 or 27 hours. The peg lid was removed after the desired exposure time, rinsed twice with 0.9% saline, and the biofilm disrupted into either fresh 0.9% saline or a “recovery plate” prepared as described above. After removal of the peg lid, the challenge plate was covered with a new sterile lid to protect the planktonic cultures. MIC values were determined after 72 h by reading the optical density of the challenge plate at 650 nm on a 96-well microtitre plate reader (Molecular Devices). Subsequently, 40 μl aliquots of the planktonic cultures were added to “neutralizing plates” prepared as described above. For the rapid determination of MBC and MBEC values used in the exposure time assays, 25 μl aliquots from each well of the recovery and neutralizing plates were spot-plated onto LB+B1 agar. The agar plates were incubated for 48 h at 37° C. and then scored qualitatively for growth.

### Quantitative Viable Cell Counts

Viable cell counts were obtained for biofilms by breaking four pegs from the peg lid and suspending them in 200 μl of 0.9% saline in a 96-well plate, which was sonicated as described above. The disrupted biofilm cultures were serially diluted ten-fold, plated onto LB+B1 agar, and incubated for 24 h at 37° C. For determination of mean viable cell counts following metal exposure, 20 μl aliquots from the wells of the “neutralizing plates” (prepared as described above) were serially diluted ten-fold in 0.9% saline and plated onto LB+B1 agar. To allow recovery of all viable bacteria surviving metal exposure, 48 h of incubation at 37<C were allowed before growth was scored on agar plates.

### Scanning Electron Microscopy (SEM)

Pegs were broken from the lid of the MBEC device, rinsed once with 0.9% saline to disrupt planktonic bacteria, and fixed with 5% glutaraldehyde in 0.1 M cacodylate buffer (pH 7.2) at 20° C. for 2 hours. Following fixation, pegs were washed with 0.1 M cacodylate buffer and then rinsed with double distilled water. Subsequently, the pegs were dehydrated with 95% ethanol and then air dried for 30 h before mounting. SEM was performed using a Hitachi model 450 scanning electron microscope as previously described (Morck et al., 1994).

### Example 3

In this study, six metals were chosen to represent groups 8B to 4A of the periodic table. All six of the metals examined in this study are commonly released into the environment as industrial emissions and effluent, and have been surveyed as part of environmental impact reports (De Vries et al., 2002; Hernandez et al., 2003). The metals—CO²⁺, Ni²⁺, Cu²⁺, Zn²⁺, Al³⁺, and Pb²⁺—were examined for toxicity against aerobically grown biofilm and planktonic cultures of the soil bacterium and opportunistic pathogen Pseudomonas aeruginosa ATCC 27853. Each metal was tested at various exposure times in either rich or minimal media. We report that with exposure times of less than 4 hours, biofilms were observed to be 2 to 25 times more tolerant to eradication by metal cations than the corresponding planktonic cultures. However, with exposure times of around 1 day, biofilm and planktonic bacteria were eradicated at approximately the same concentration in almost every instance. Viable cell counts revealed that at higher concentrations, many of the metal cations had killed greater than 99.9% of biofilm and planktonic cell populations. We suggest that the survival of less than 0.1% of the bacterial population corresponds well with the hypothesis that a small population of persister cells may be largely responsible for the observed tolerance of both logarithmic-growing planktonic cells and biofilms to metals.

### Biofilm Formation

Biofilms of Pseudomonas aeruginosa ATCC 27853 were grown to a mean density of approximately 6.0×10⁶ cfu/peg in LB+B1 and 1.0×10⁶ cfu/peg in MSVP in 9.5 and 22 h of incubation, respectively. For every assay, four pegs were broken from the lid of the MBEC_{J} device (see for example, U.S. Pat. Nos. 5,454,886; 5,837,275; 5,985,308 and 6,017,553, among others) and viable cell counts determined to ensure that the appropriate number of bacteria had formed in the biofilm. One-way analysis of variance (ANOVA) was used to demonstrate that the biofilms formed on the pegs of the MBEC_{J} device were statistically equivalent between different assays in the same media (data not shown).

Scanning electron microscopy (SEM) was used to examine the biofilms grown on the pegs of the MBEC_{J} device. Biofilms grown in LB+B1 formed a bacterial layer several cell widths in thickness across the surface of the peg. In contrast, biofilms grown in MSVP covered the surface of the peg in heterogeneously distributed lumps and mounds. These observations were consistent with previous data reported by our research group (Ceri et al., 1999; Olson et al., 2002; Harrison et al., 2004) and indicate that the peg surface is covered with a viable biofilm and not simply adherent planktonic bacteria.

### Example 4

The mean and standard deviation (SD) of all MIC, MBC₁₀₀, and MBEC values are reported for P. aeruginosa ATCC 27853 to Co²⁺, Ni²⁺, Cu²⁺, Zn²⁺, Al³⁺, and Pb²⁺ in Table 1. Large standard deviations imply that the metal ion inhibited bacterial growth or eradicated over a range of concentrations. The MIC values determined using the MBEC_{J}-HTP assay did not change with exposure time (data not shown) and the values reported in Table 1 are the mean and standard deviation of 28 trials. MBC₁₀₀ and MBEC determinations were repeated 4 to 7 times each. Reproducibility of MIC values served as an internal control to eliminate dilution error of the metal compounds in the challenge plates. To minimize precipitation, metal cations were tested in MSVP.

Notably, the heavy metal Ni²⁺ had the lowest observed MIC of all the metals assayed (0.60 mM), although it was not observed to eradicate either biofilm or planktonic cultures at concentrations of 140 mM. In general, the ratio of MBEC:MBC₁₀₀ values—which we will define here as “fold tolerance”—decreased with time. For example, with 2 hours exposure time, biofilms were observed to be 13 times more tolerant to eradication by Cu²⁺ than planktonic cultures. However, with 27 hours of exposure time, the fold tolerance was 1.1. With 2 hours of exposure, biofilms were 25 times more tolerant to eradication by Al³⁺ relative to the corresponding planktonic cultures. Biofilms were killed sporadically with 6 h exposure to A1³⁺ and by 27 hours, biofilms exhibited a fold tolerance of only 0.7. Collectively, the data summarized in Table 1 indicate that biofilms are killed in a time dependent fashion by metal cations, and that with long exposure times, biofilm and planktonic bacteria are equally susceptible to eradication by these compounds.

### Example 5

### Susceptibility of Pseudomonas aeruginosa to Metal Toxicity in Rich Media

To compare the susceptibility of P. aeruginosa biofilm and planktonic cultures to metal cations in different media, the MBEC_{J}-HTP assay was additionally used to screen all of the metals in LB+B1 at 2 and 27 h of exposure. The mean and standard deviation for MIC, MBC₁₀₀ and MBEC values of P. aeruginosa to Co²⁺, Ni²⁺, Cu²⁺, Zn²⁺, Al³⁺, and Pb²⁺ are reported in Table 2 (4 replicates each). The data for Ni²⁺, Cu²⁺, Zn²⁺, and Al³⁺ at 27 h were similar and consistent with the previous report of Harrison et al. (2004) at 24 h of exposure. Co²⁺ and Pb²⁺ were not examined in this initial study in rich media. With 2h of exposure, biofilms were observed to be 2.7 to 4.5 times more tolerant to metal toxicity than the corresponding planktonic cultures. Concurrent with the data in Table 1, by 27 h of exposure in rich media, biofilms were observed to be at most 2 times more tolerant to metal toxicity than the corresponding planktonic cultures. In the cases of Cu²⁺, Al³⁺, and Pb²⁺, biofilms were eradicated at approximately the same concentration of metal cations as planktonic cultures. The MIC, MBC₁₀₀ and MBEC values were to some extent greater in LB+B1 than in MSVP.

### Example 6.

### Log-killing of Pseudomonas aeruginosa Biofilms by Metal Cations

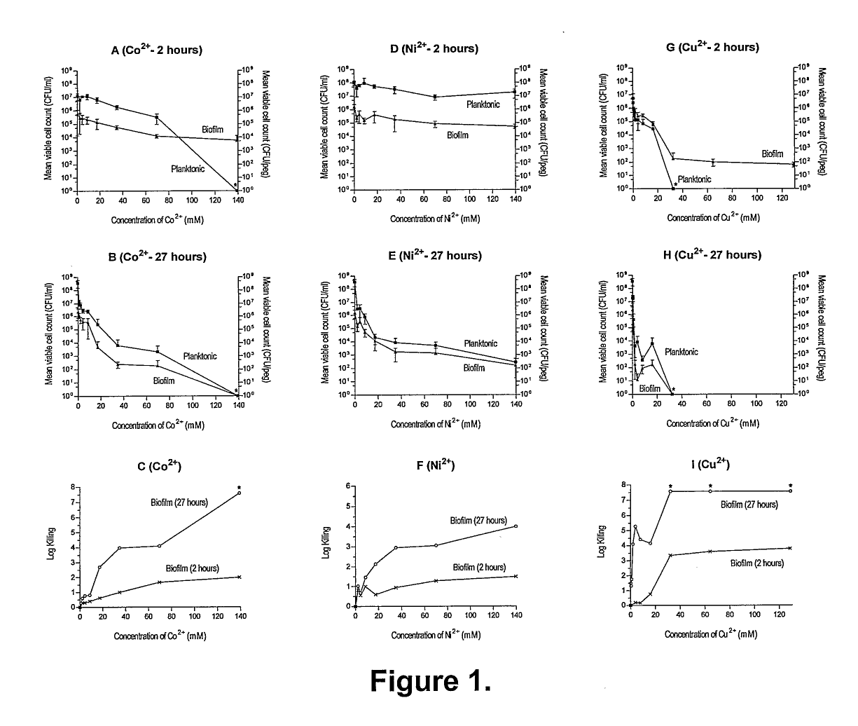

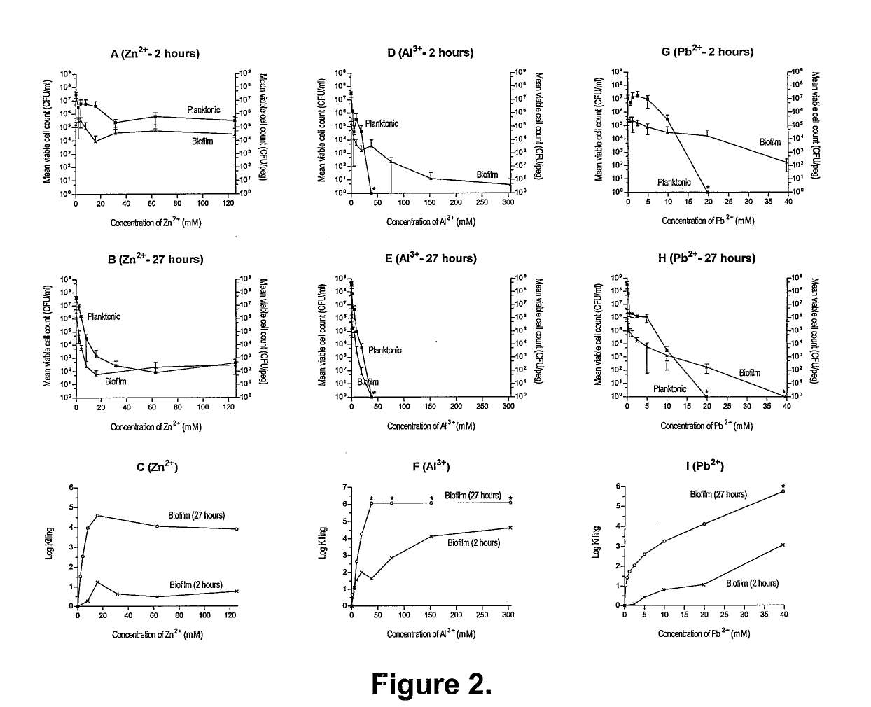

To examine the survival of planktonic and biofilm bacterial populations following exposure to metal cations, viable cell counts were determined for a range of concentrations following either 2 or 27 h of exposure in MSVP. Mean viable cell counts and log-killing of biofilm cultures for Co²⁺, Ni²⁺, and Cu²⁺ (Groups 8B and 1B) are reported in FIG. 1, and for Zn²⁺, Al³⁺, and Pb²⁺ (Groups 2B to 4A) are reported in FIG. 2. In all of these assays, high concentrations of metals were observed to kill 99.9% or greater of both planktonic and biofilm bacterial populations with 27 h exposure. This was also the case with Cu²⁺, Al³⁺, and Pb²⁺ by 2 h of exposure. In contrast, Co²⁺, Ni²⁺ and Zn²⁺ killed 50 to 90% of the bacterial population with 2 hours of exposure. Unlike planktonic cultures, which were quickly eradicated by metal cations, in no instance were biofilms eradicated within 2 h of exposure. In contrast, with 27 h of exposure biofilm bacteria were eradicated nearly as efficaciously as planktonic populations. The survival of less than 0.1% of the bacterial population was particularly germane in the cases of Ni²⁺ (FIG. 1, Panels D, E, and F) and Zn²⁺ (FIG. 2, Panels A, B, and C). P. aeruginosa did not grow at low concentrations of these divalent heavy metal cations (MIC=0.60 and 9.5 mM, respectively). However, the surviving population was observed to tolerate Ni²⁺ and Zn²⁺ at concentrations in excess of 140 mM and 125 mM, respectively. This phenomenon coincided with less than 0.1% survival of the biofilm and planktonic cell populations.

Panels C, F and I (FIGS. 1 and 2) indicate the proportion of the biofilm killed (i.e., log-kill) at 2 and 27 h of exposure. In every instance, the greater exposure time corresponded with an increase in the log-kill of the biofilm. As a control, biofilms not exposed to metals were enumerated after an equal exposure time and were shown to be statistically equivalent (using one-way ANOVA) to the initial biofilm counts before exposure (data not shown). These controls eliminated the possibility that the observed increase in log kill was simply due to the natural dispersion of the biofilm with time. One of the features of the MBEC_{J}-HTP assay is that the wells of the microtitre plates containing serial dilutions of metals are inoculated with bacteria shed from the surface of the peg lid. Consequently, a precise initial number of planktonic bacteria is unknown, and log-killing of planktonic bacteria cannot be calculated using this method. However, this situation in vitro may be reflective of naturally existing environmental systems (or as a model of infection) where a biofilm forms a recalcitrant nucleus that sheds planktonic cells into its surrounding. In general, our data indicate that 0.1% or less of the bacterial population is responsible for the observed tolerance of both planktonic and biofilm P. aeruginosa to high concentrations of metals. Further, a comparable portion of the biofilm population (less than 0.1%) survived for a longer period of time than it did for planktonic cultures. However, the metals Co²⁺, Cu²⁺, Al²⁺, and Pb²⁺ all allowed for complete eradication of the biofilm cultures with extended exposure times (27 hours).

### Example 7

The extracellular polymeric matrix of P. aeruginosa is an ionic mishmash of amino acids (Sutherland, 2001), nucleotides (Whitchurch et al., 2002), and derivative sugars (Wozniak et al., 2003). Simple diffusion of an inert (non-reactive) ion across a biofilm matrix is slow. Using chloride (Cl⁻) as an example, diffusion across a 1000μm thick biofilm requires more than 16 minutes (Stewart et al., 2001). Diffusion of chloride ions may be restricted through ionic interactions with positively charged amino groups of peptides and derivative polysaccharides. Similarly, metal cations may ionically interact with negatively charged carboxylate or phospodiester groups thereby retarding their diffusion into the biofilm matrix. However, metal cations may also covalently react with thiolates, sulphates and phosphates, effectively becoming sequestered in the biofilm extracellular polymeric substance. Having the metals coordinated in the biofilm matrix (thus sequestering the metal away from the cell) would provide protection until the matrix saturates. This would result in local metal concentrations greater than the bulk media. The kinetics of the reaction equilibriums likely influence both biological availability and diffusion dynamics. This ability of heavy metals and metalloids to adsorb to microbial biofilm extracellular polymeric matrix has recently been exploited as a means for detecting industrial pollutants in rivers (Mages et al., 2004).

There are other considerations that may influence metal tolerance in the bacterial biofilm. To date, the molecular mechanisms of antimicrobial tolerance in biofilms remain elusive and ill-defined. First, the rate of metal accumulation inside the bacterial cell may be influenced by either reduced cellular uptake or through efflux systems (Silver, 1998; Nies, 2003). Although the majority of planktonic cell metal resistance determinants in prokaryotes are membrane bound efflux pumps (Silver, 1998), the precise mechanisms at work in a biofilm are poorly explored. The second challenge revolves around studying the “persistent” phenotype, which is complicated by the natural low frequency and unknown functional significance of persister cells. Within the limits of our current understanding, persisters may only be defined as the small, dormant, physiologically distinct subpopulation of bacterial cells capable of withstanding environmental duress.

### Example 8

Killing of Pseudomonas aeruginosa ATCC 27853 cell populations by representative heavy metals from groups 8B and 1B of the periodic table. Biofilm and logarithmic-phase planktonic cultures were exposed to Co²⁺, Ni²⁺, or Cu²⁺ for 2 hours (FIG. 1, Panels A, D and G, respectively) or 27 hours (FIG. 1, Panels B, E, and H, respectively) and then plated for viable cell counts. The data for biofilm cultures is plotted in units of CFU per peg in the MBEC_{J} device. Each data point was calculated from 3 replicates and the error bars indicate standard deviation. Absence of a lower error bar indicates that the standard deviation calculated was greater than the mean. Given the sensitivity of the assay on a log₂ scale, with 2 hours of exposure biofilms were observed to be at least 2 and 13 times more tolerant to Co²⁺ and Cu²⁺ toxicity than corresponding planktonic cultures, respectively. Notably, Ni²⁺ did not eradicate biofilm or planktonic cultures even at concentrations of 140 mM. Log-killing of biofilm cultures (FIG. 1, Panels C, F and I for Co²⁺, Ni²⁺, and Cu²⁺, respectively) indicate that less than 0.1% of the bacterial population survived 27 h exposure at high concentrations of these heavy metals. The “*” indicates a concentration where the corresponding bacterial culture was eradicated; squares indicate planktonic bacteria, triangles indicate biofilm bacteria, circles represent log-killing of biofilms at 27 h, and crosses represent log-killing of biofilms at 2 h.

### Example 9

Killing of Pseudomonas aeruginosa ATCC 27853 cell populations by representative metals from groups 2B to 4A of the periodic table. Biofilm and logarithmic-phase planktonic cultures were exposed to Zn²⁺, Al³⁺, or Pb²⁺ for 2 hours (FIG. 2, panels A, D and G, respectively) or 27 hours (FIG. 2, Panels B, E, and H, respectively) and then plated for viable cell counts. The conditions and data analysis were as described in the legend to FIG. 1. Log-killing of biofilm cultures (Panels C, F and I for Zn²⁺, Al³⁺, and Pb²⁺, respectively) indicate that less than 0.1% of the bacterial population survived 27 h exposure to high concentrations of these heavy metals. With 2 h exposure to Zn²⁺ (Panel A) 90-99% of the biofilm was killed. With 2 h (FIG. 2, Panel D) or 27 h (FIG. 2, Panel E) of exposure to Pb²⁺, planktonic cultures were eradicated at the same concentration. In contrast, biofilms survived 2 h exposure, but by 27 h, were eradicated at the highest concentration of Pb²⁺ used in this study. This implies that P. aeruginosa biofilms remained slightly more tolerant to Pb²⁺ than the corresponding planktonic cultures. Biofilms were 25 times more tolerant to Al³⁺ at 2 h exposure than corresponding planktonic cultures (FIG. 2, Panel D). However, by 27 h the biofilms were eradicated at the same concentration of Al³⁺ as planktonic cultures (FIG. 2, panel E). The “*” indicates a concentration where the corresponding bacterial culture was eradicated; squares indicate planktonic bacteria, triangles indicate biofilm bacteria, circles represent log-killing of biofilms at 27 h, and crosses represent log-killing of biofilms at 2 h.

### Example 10

In total, 17 metal cations and oxyanions, chosen to represent groups VIB to VIA of the periodic table, were each tested on biofilm and planktonic cultures of Escherichia coli JM109, Staphylococcus aureus ATCC 29213, and Pseudomonas aeruginosa ATCC 27853. In contrast to control antibiotic assays, where biofilm cultures were 2 to 64 times less susceptible to killing than logarithmically growing planktonic bacteria, metal compounds killed planktonic and biofilm cultures at the same concentration in the vast majority of combinations. Our data indicate that, under the conditions reported, growth in a biofilm does not provide resistance to bacteria against killing by metal cations or oxyanions.

In this study, we tested each of 17 different metal compounds on Escherichia coli JM109, Pseudomonas aeruginosa ATCC 27853, and Staphylococcus aureus ATCC 29213 biofilm and planktonic cultures. We assayed metal susceptibility in three ways: inhibition of planktonic growth (minimum inhibitory concentration, “MIC”), killing of planktonic bacteria (minimum bactericidal concentration, “MBC”) and killing of biofilm bacteria (minimum biofilm eradication concentration, “MBEC”). In control antibiotic assays, the planktonic cells were generally killed at lower antimicrobial concentrations than biofilm cells (i.e. MBC<MBEC). In contrast, metal compounds killed planktonic and biofilm bacteria at the same concentration in the vast majority of combinations (i.e. MBC=MBEC). Our data indicate that with similar growth conditions and exposure times to control antibiotic assays, biofilm growth does not afford any additional resistance to bacteria against metal toxicity.

### Example 11

### Biofilm Formation.

E. coli, P. aeruginosa, and S. aureus biofilms were grown to an equivalent mean density of approximately 6.0×10⁶ cfu/peg on the MBEC_{J}-HTP assay plate in 24, 9 and 24 h of incubation respectively. Viable cell counts were determined to ensure that the appropriate number of cells had formed in the biofilm. One-way analysis of variance (ANOVA) was used to demonstrate that the biofilms formed by the 3microorganisms were statistically equivalent (data not shown). Scanning electron microscopy (SEM) was used to examine biofilm formation on the pegs of the MBEC_{J} device. SEM photographs for P. aeruginosa ATCC 27853 show the formation of a thick bacterial layer encased in an extracellular polymeric matrix. The SEM photographs are consistent with previous electron microscopy studies by our research group (Ceri et al., 1999; Olson et al., 2002) and verify that the pegs are covered with viable biofilms and not simply adherent planktonic bacteria.

### Relative Levels of Resistance of Planktonic Bacteria and Biofilms to Antibiotics.

To verify that the resistance trends observed using the MBEC_{J} device were not an artifact of technique, antibiotics were tested on the model microorganisms. Antibiotic MIC, MBC and MBEC values observed for E. coli JM109, S. aureus ATCC 29213, and P. aeruginosa ATCC 27853 planktonic and biofilm cultures are summarized in Tables 3, 4 and 5, respectively. Mean values and standard deviation (SD) are reported for all MIC, MBC and MBEC values. To be consistent with NCCLS standards for antibiotic susceptibility testing, all values are reported in units of μg/ml. The data were consistent with results previously reported by our research group (Ceri et al., 1999; Olson et al., 2002). Biofilm cultures were 2 to 64 times less susceptible to killing by antibiotics than logarithmically growing planktonic cultures. MBEC values were 2 to 512 times greater than MIC values (i.e. MIC<MBC<MBEC). Each antibiotic assay was performed 3 to 8 times. E. coli JM109 was most susceptible to antibiotics, S. aureus was of intermediate resistance, and P. aeruginosa was highly resistant. In only one instance was the MBC=MBEC, and this was in the case of S. aureus susceptibility to the aminoglycoside gentamicin. ps Relative Levels Of Resistance of Planktonic Bacteria and Biofilms to Metal Toxicity

Tables 6, 7, and 8 summarize metal cation and oxyanion MIC, MBC and MBEC values observed for E. coli, S. aureus, and P. aeruginosa planktonic and biofilm cultures, respectively. Mean values and standard deviation (SD) are reported for all MICs, MBCs and MBECs. Note that generally, there was less than a log₂ deviation between the values obtained (i.e. one well on the serial two-fold dilution challenge plate), and frequently the same value was obtained in every trial for the same compound (i.e. SD=0). Larger SD values imply that the metal compound killed over a range of concentrations. We examined a total of 51 assay combinations of metal compounds and bacterial strains (17 metal cations and oxyanions tested on each of the 3 microorganisms), and screened each assay combination 3 to 8 times using the MBEC_{J} device.

In 49 of the 51 metal toxicity assay combinations performed, the MBC was approximately equal to the MBEC. In 10 of the 51 assay combinations the MIC, MBC and MBEC were approximately equal. E. coli JM109 was most susceptible to metal toxicity, S. aureus was of intermediate resistance, and P. aeruginosa was highly resistant. Out of all 51 metal toxicity assay combinations, the MBEC was at most 64 times greater than the MIC. In one assay the MBEC was greater than the MBC (S. aureus resistance to Ag⁺), and in contrast, in one assay the MBC was greater than the MBEC (S. aureus resistance to TeO₃²⁻). The three most toxic compounds to each organism are in boldface on Tables 6, 7, and 8.

### Example 12

We assayed susceptibility to metal oxyanions and cations in three ways: inhibition of planktonic growth (MIC) and killing of planktonic and biofilm bacteria (MBC and MBEC, respectively). In 49 of 51 possible assay combinations of metals and microorganisms, it was observed that the MBC was approximately equal to the MBEC, which contrasts with the control trend of antibiotic susceptibility, where the MBEC was observed to be 2 to 64 times greater than the MBC. The observed trend of antibiotic susceptibility, in which MBECs were observed to be 2 to 512 times greater than MICs, corresponds well with previously reported results (Ceri et al., 1999; Olson et al., 2002). Collectively, our data suggest that growth in a biofilm, under similar experimental conditions to control antibiotic susceptibility testing, does not provide bacteria with resistance against metal toxicity.

Consistently, Hg²⁺, TeO₃²⁻, and Ag⁺ were observed to be the three most toxic compounds to the microorganisms screened in this study. This is a relative statement with respect to the organism. For example, P. aeruginosa was almost 5 times more resistant to tellurite than S. aureus, and 100 times more resistant to this metalloid oxyanion than E. coli. The group IB cation Cu²⁺ and the group VIB oxyanion CrO₄²⁻ also exhibited high toxicity to both the Gram-negative and Gram-positive bacteria. Surprisingly, the group IIIA post-transition metal cation, Al³⁺, was observed to have high toxicity to P. aeruginosa, killing planktonic and biofilm cultures at lower molar concentrations than the heavy metal cations Zn²⁺, Ni²⁺ and Cd²⁺. Due to its low atomic mass, gram for gram, Al³⁺ was the third most toxic compound to P. aeruginosa.

In general, the biological toxicity of a compound within a chemical group increased with the principal quantum number. This trend was observed for the group IB and IIB cations, and for the group VIA oxyanions. There was one notable exception to this trend. Chromate (CrO₄²⁻) was consistently observed to have much higher toxicity relative to either molybdate (MoO₄²⁻) or tungstate (WO₄²⁻). Speciation of oxidation state(s) and chemical reactivity underlie the levels of biological toxicity. No correlation between MIC, MBC and MBEC values and oxidation state or standard reduction potentials of the metal compounds could be discerned.

Here, the observed MIC, MBC and MBEC values for P. aeruginosa resistance to Cu²⁺ and Zn²⁺ were greater than those previously described (de Vincente et al., 1990; Geslin et al., 2001; Teitzel and Parsek, 2003). However, the MIC values for the metalloid oxyanions tellurite, tellurate and selenite in E. coli correspond well to previously reported results obtained using alternate microbiological methods (Turner et al., 1999). It has been previously reported that with 5 h exposure times and in various minimal growth media, P. aeruginosa biofilms are 2 to 600 times more resistant to the heavy metals Cu²⁺, Zn²⁺ and Pb²⁺ than either logarithmic phase or stationary phase planktonic bacteria (Teitzel and Parsek, 2003). Using the methods described in this paper, a second study has recently been completed by our research group addressing the apparent differences between our data and the results of Teitzel and Parsek (2003).

We have observed that the killing of biofilm and planktonic bacteria is time-dependent (Harrison et al., unpublished data). In minimal media with shorter exposure times (ie. 2 to 6 hours), biofilms were killed by metal cations and oxyanions at up to 16 fold higher concentrations than corresponding planktonic cultures (Harrison et al., unpublished data). However, when this minimal media experiment was repeated with a 24 h exposure time, biofilms were killed at approximately the same concentration as planktonic cells in the majority of combinations (Harrison et al., unpublished data). Together, our studies suggest that bacterial biofilm formation is not an innate mechanism of metal resistance per se, but rather a time-dependent mechanism of tolerance.

These observations are consistent with the “restricted penetration” hypothesis (Lewis, 2001) and are supported by the scanning confocal laser microscopy (SCLM) data of Teitzel and Parsek (2003). The biofilm extracellular polymeric matrix is ionic, containing a heterogeneous combination of positive and negative charges on polypeptides (Sutherland, 2001), nucleic acids (Whitchurch et al., 2002), and derivative polysaccharides (Razatos et al., 1998; Wozniak et al., 2003). Hypothetically, the dynamics of ion-exchange across this exopolymeric matrix may restrict diffusion of metal and metalloid ions, but may only postpone cell death rather than provide enhanced resistance. The time required for a metal ion to penetrate the biofilm would be dependent on its chemical reactivity with components of the biofilm matrix. Time-dependent killing kinetics of biofilms by heavy metals will be the focus of a forthcoming paper by our research group.

The exhaustive approach to metal toxicity susceptibility testing undertaken in this study suggests that metal tolerance in the bacterial biofilm is fundamentally different than antibiotic tolerance. Whereas antibiotic tolerance is a robust hallmark of biofilm bacteria, under the growth and exposure conditions described here, planktonic and biofilm bacteria are equally susceptible to killing by metal cations and oxyanions.

### Example 13

### Bacterial Strains and Media

Escherichia coli JM109 (a standard laboratory strain used commonly in the study of metal resistance), Pseudomonas aeruginosa ATCC 27853 (a wild type, clinical isolate) and Staphylococcus aureus ATCC 29213 (a wild type, quality-control isolate) were stored at −70° C. in 8% w/v DMSO in Luria-Bertani medium (pH 7.1, 5 g NaCl, 5 g yeast extract, and 10 g tryptone per liter of double distilled water) enriched with 0.01% w/v vitamin B1 (LB+B1). Assays for metal toxicity were performed using LB+B1 media, and subcultures, MBC, and MBEC bacterial counts were performed on plates containing LB+B1 with 1.5% w/v granulated agar. Luria-Bertani medium was chosen for two reasons: 1) its established use in studies of metal resistance, and 2) because of the use of rich media in NCCLS testing protocols for antimicrobial resistance. Antibiotic resistance assays were performed using cation-adjusted Mueller-Hinton broth (CA-MHB, BDH Inc.) and subcultures, MBC and MBEC bacterial counts were performed using trypticase soy agar (TSA, Difco).

### Biofilm Formation

The present study used a novel high throughput method for screening biofilm susceptibility to metal cations and oxyanions: the MBEC device (MBEC Bioproducts Inc., Edmonton, Alberta, Canada, http://www.mbec.ca). The MBEC high throughput (MBEC-HTP) assay system consists of a shallow trough into which a plastic lid with 96 pegs fits. This peg lid also fits over a standard 96-well microtitre plate which can subsequently be used to setup serial dilutions of antimicrobial compounds. The bottom half of the MBEC device is a trough that has shallow channels that direct flow of an inoculated suspension over the pegs on the lid. When the MBEC_{J} device is placed on a rocker, the shear force facilitates the formation of 96 statistically equivalent biofilms on the pegs (Ceri et al., 1999; Ceri et al., 2001).

In our experiments, the inoculum for the MBEC_{J} device was prepared by direct-colony suspension from 2^{nd}-subcultures grown for 18 to 24 h at 35° C. on LB+B1 agar plates (metal assays) or TSA (antibiotic assays) as previously described (ie. the strains were streaked out twice and then the MBEC_{J} device was inoculated from colonies resuspended in growth medium) (Ceri et al., 1999; Ceri et al., 2001). The inoculum was standardized to a 1.0 McFarland standard and verified by viable counts. The 1.0 McFarland standard inoculum was diluted 30-fold with growth media, which served as the growth suspension to inoculate the MBEC_{J} device.

The biofilm was then formed in the MBEC_{J} device at 35° C. and 95% relative humidity on a rocking table (Red Rocker model, Hoefer Instrument Co.) as previously described (Ceri et al., 1999; Ceri et al., 2001). P. aeruginosa was incubated for 9 h, S. aureus for 24 h and E. coli for 24 h to generate approximately equivalent biofilms of 6.0×10⁶ cfu/peg. Following the incubation period, growth of biofilm and planktonic cultures in the MBEC_{J} device were discerned and verified by viable cell counts. Biofilms were disrupted from individual pegs broken from the lid, or from all pegs at once, by sonication for 5 min on high with an Aquasonic sonicator (model 250HT, VWR Scientific) as previously described (Ceri et al., 1999; Ceri et al., 2001).

### Stock Antibiotic Solutions

Amikacin (ICN Biomedicals), Ampicillin (Sigma), Cefazolin (Sigma), Ciprofloxacin (Bayer), Gentamicin (Sigma), Piperacillin (Sigma), and Tobramycin (Sigma) were prepared as stock solutions in double-distilled water at 5120 μg/ml, syringe-filtered, and stored at −70° C. Chloramphenicol (Sigma) was prepared in 50% ethanol and treated identically to the other antibiotics. 10% ethanol was added to the growth controls for chloramphenicol assays. Working solutions were prepared the day of use at 1024 μg/ml in CA-MHB. Starting with the working solutions, serial two-fold dilutions were made in the wells of a 96-well plate (the challenge plate), leaving the first well of each row as a sterility control and the second as a growth control (i.e. no antibiotic).

### Stock Metal and Metalloid Solutions

Sodium hydrogen arsenate (Na₂HAsO₄), silver nitrate (AgNO₃), aluminum sulfate (Al₂(SO₄)₃.18H₂0), zinc sulfate (ZnSO₄.7H₂O), stannous chloride (SnCl₂.2H₂O) and copper sulfate (CuSO₄.5H₂O) were obtained from Fisher Scientific Company of Fairlawn, N.J. Potassium dichromate (K₂Cr₂O₇) was obtained from J.T. Baker Chemical of Phillipsburg, N.J. Sodium arsenite (NaAsO₂), nickel sulfate (NiSO₄.6H₂O), mercuric chloride (HgCl₂), potassium tellurite (K₂TeO₃) and sodium tungstate (10% w/v aqueous solution Na₂WO₄) were obtained from Sigma Chemical Company of St. Louis, Mo. Cadmium chloride (CdCl₂.5/2H₂O) was obtained from Terochem Laboratories of Edmonton, AB, selenous acid (H₂SeO₃) from The British Drug Houses Limited of Poole, England, manganous sulfate (MnSO₄.H₂O) from BDH Inc. of Toronto, ON, potassium tellurate (K₂TeO₄) from Johnson Mathey Electronics of Ward Hill, Mass. and sodium molybdate (Na₂MO₄) from Matheson Coleman and Bell of Norwood, Calif. Top quality, reagent grade metal and metalloid compounds were purchased for the purposes of this study to minimize the potential influence of contaminating, residual metals.

All stock metal solutions, with the exception of Sn²⁺, were made up in double-distilled water, syringe-filtered into sterile glass vials, and stored at 20° C. Sn²⁺ was disolved in 50% ethanol and stored in a sterile polypropylene tube. 10% ethanol was added to the growth controls for tin(II) assays. Stock solutions of Sn²⁺, TeO₃²⁻, and TeO₄²⁻ were heated to 60° C. to aid with dissolution of the stock metal compound immediately prior to preparation of the working solutions. Working solutions were prepared in LB+B1 broth from stock metal cation or oxyanion solutions no more than 60 minutes prior to biofilm exposure. From these, serial two-fold dilutions were made in the wells of a 96-well plate (the challenge plate), leaving the first well of each row as a sterility control and the second for a growth control (i.e. no metal compound).

### Stock Neutralizing Agents

Metal and metalloid oxyanions, Cd⁺, and Zn²⁺ were neutralized using 5 mM reduced glutathione (GSH, Sigma). GSH is used by the bacterial cell as a reduction-oxidation buffer to reductively eliminate a diverse array of inorganic toxins, and is thus the basis for its use as a neutralizing agent (Aslund et al., 1999; Taylor, 1999; Turner et al., 1999). Sn²⁺ was chelated using 5 mM glycine (BIO-RAD) (Diurdjevic and Djokic, 1996). Ag⁺ was chelated using 5 mM sodium citrate (Fisher), and Hg²⁺ was neutralized using 5 mM L-cysteine (Sigma) (Russel et al., 1979). Al³⁺ and Mn²⁺ were chelated using approximately 5 mM 5-sulfosalicylic acid (Sigma) (Graff et al., 1995; Missy et al., 2000). Cu²⁺ and Ni²⁺ were neutralized using 5 mM diethlydithiocarbamate (DDTC, ICN Biochemicals) (Gottofrey et al., 1988; Agar et al., 1991). DDTC is an efficacious neutralizing agent but is also inhibitory to bacterial growth (Agar et al., 1991). Incubation times were doubled for all assays involving the use of DDTC, and only the growth of bacteria on agar plates could be used to discern MBC and MBEC values for these assays (see below).

Stock solutions of citrate (0.5 M), DDTC (0.25 M), glutathione (0.25 M), 5-sulfosalicylic acid (0.25 M) and L-cysteine (0.25 M) were prepared in double-distilled water, sterile filtered, and stored at −20° C. until use. Neutralizing agents for biofilm cultures were added directly to LB+B1 broth used in the recovery plates. Neutralizing agents for the planktonic cultures were prepared at 5 times the desired neutralizing concentration in 0.9% saline. 10 μl aliquots of the diluted stock solutions were then added to the wells of a sterile 96-well plate (the neutralizing plate) to which 40 82 l from each well of the challenge plate were added. The final concentration of neutralizing agent used to treat the planktonic cultures was thus equal to that used to treat biofilm cultures. 30 minutes were allowed for the neutralizing reaction to occur.

### Biofilm and Planktonic Culture Susceptibility Testing

i. Antibiotics.

Biofilms formed on the lid of the MBEC_{J} device were rinsed once with 0.9% saline and transferred to standard 96-well plates in which serial two-fold dilutions of the antibiotics (the challenge plates) were prepared as described above. The challenge plates were then incubated for 24 h at 35° C. and 95% relative humidity. At the end of the incubation period, the peg lid was removed and rinsed twice with 0.9% saline, and the biofilms disrupted by sonication into CA-MHB in a new, sterile 96-well plate (the recovery plate). After removal of the peg lid, the challenge plate was covered with a new, sterile lid to protect the planktonic cultures in the challenge plate wells. MICs were obtained by reading the turbidity of the challenge plate at 650 nm on a 96-well plate reader (Molecular Devices, Fisher Canada) after 72 h as previously described (Ceri et al., 2001). MBCs were determined qualitatively by spotting 25 μl from each of the wells onto TSA, followed by incubation at 35° C. for 24 to 48 h. MBECs were determined qualitatively by spotting 25 μl from each of the wells of the recovery plate onto TSA, followed by incubation at 35° C. for 24 to 48 h. MBECs were redundantly determined by reading the turbidity of the recovery plate on a plate reader after 24 to 48 h incubation at 35° C. and 95% relative humidity, as previously described (Ceri et al., 1999; Ceri et al., 2001).

ii. Metal Oxyanions and Cations.

Biofilms formed on the lid of the MBEC_{J} device were rinsed once with 0.9% saline and transferred to standard 96-well plates in which serial two-fold dilutions of the metal cations and oxyanions (the challenge plates) were prepared. The challenge plates were then incubated for 24 h at 35° C. and 95% relative humidity. The peg lid was removed and rinsed twice with 0.9% saline, and the biofilm disrupted by sonciation into LB+B1 broth containing the appropriate neutralizing agent. After removal of the peg lid, the challenge plate was covered with a new, sterile lid to protect the planktonic cultures in the challenge plate wells. MICs were determined by reading the turbidity of the challenge plate at 650 nm on a 96-well plate reader. Subsequently, 40 μl aliquots were taken from the challenge plate and added to the corresponding well of the neutralization plate, which was prepared as described in the section above. MBCs were qualitatively determined by spotting 25 μl from each well of the neutralization plate onto LB+B1 agar, and incubating for 24 to 48 h at 35° C. MBECs were determined qualitatively by spotting 25 □l from each well of the recovery plate onto LB+B1 agar, followed by incubation at 35° C. for 24 to 48 h. With the exception of Cu²⁺ and Ni²⁺ assays, MBECs were redundantly determined by reading the turbidity of the recovery plate at 650 nm on a 96-well plate reader after 24 to 48 h incubation at 35° C. and 95% relative humidity, as previously described (Ceri et al., 1999; Ceri et al., 2001).

iii. Quantitative Viable Cell Counts.

Viable cell counts were obtained for biofilms by breaking off four pegs from the peg lid and suspending them in 200 μl of 0.9% saline in a 96-well plate, which was subsequently sonicated as described above. The disrupted biofilm cultures were serially diluted ten-fold, plated onto LB+B1 agar and incubated for 24 h at 35° C.

### Scanning Electron Microscopy (SEM)

Pegs were broken from the lid of the MBEC_{J} device and fixed with 5% glutaraldehyde in 0.1 M cacodylate buffer (pH 7.2) at 4° C. overnight. Following fixation, pegs were washed with 0.1 M cacodylate buffer, dehydrated with 95% ethanol, and air dried for 30 h before mounting. SEM was performed using a Hitachi model 450 scanning electron microscope as previously described (Morck et al., 1994).

### Example 14

Table 9 shows the resistance of Pseudomonas aeruginosa biofilms to metal and antibiotic combinations (all values in μg/ml).
*The MIC for amikacin in the presence of 200 μg/ml Cu²⁺ is 256 times less than the MIC for amikacin alone.
**The MBEC for ciprofloxacin in the presence of 200 82 g/ml Cu²⁺ is at least 16 times less than the MBEC for ciprofloxacin alone.

### Notes on Methods

### Cells were grown to a mean density of 6.0×10⁶ cfu/peg in LB+B1 media.

1. No neutralizing agents were employed as the quantity of metal used in combination assays was less than 2 of the MIC for the metal alone.
2. All data are median values based on 4 replicates.

### Example 15

Biofilms were grown and tested substantially as described in Examples 1 and 2. In this example, the assay follows killing of Pseudomonas aeruginosa 15442 in a matrix assay of polycide (a quaternary ammonium compound) versus each of the metals. Polycide alone is effective at 800 ppm and losses efficacy at 400 ppm and lower. In synergy matrix assays strong antibacterial activity was seen at polycide concentrations as low as 100 ppm in combination with copper cations (e.g., Cu²⁺) as low as 32 micrograms/ml. Polycide concentrations could be dropped to as low as 25 ppm but required copper levels up to 256 micrograms/ml for efficacy.

In this assay, adding as little as 16 micrograms per ml of Cu²⁺ appeared to quadruple the efficacy of the polycide.

Additionally, zinc ions (e.g., Zn²⁺) did not appear to have any synergistic effect on polycide activity. This point is interesting as triclosan-zinc combinations have been marketed.

### REFERENCES

Agar, N. S., Mahoney, J. R., and Easton, J. W. (1991) Hemolytic and microbicidal actions of diethlydithiocarbamic acid. Biochem. Pharmacol. 41: 985-993.

Bigger, J. W. (1944) Treatment of staphylococcal infections with penicillin. Lancet ii: 497-500.

Brown, G. E., Foster, A. L., and Ostergren, J. D. (2003) Mineral surfaces and bioavailability of heavy metals: A molecular-scale perspective. Proc. Natl. Acad. Sci. USA 96: 3388-3395.

Ceri, H., Olson, M. E., Stremick, C., Read, R. R., Morck, D. W., and Buret, A. G. (1999) The Calgary Biofilm Device: New technology for rapid determination of antibiotic susceptibilities in bacterial biofilms. J. Clin. Microbiol. 37: 1771-1776.

Ceri, H., Olson, M. E., Morck, D. W., Storey, D., Read, R. R., Buret, A. G., and Olson, B. (2001) The MBEC assay system: Multiple equivalent biofilms for antibiotic and biocide susceptibility testing. Methods Enzymol. 337: 377-384.

Costerton, J. W., Stewart, P. S., and Greenberg, E. P. (1999) Bacterial biofilms: a common cause of persistent infections. Science 284: 1318-1322.

De Vries, W., Vel, E., Reinds, G. J., Deelstra, H., Klap, J., Leeters, E. et al. (2002) Intensive monitoring of forest ecosystems in Europe 1. Objectives, set-up and evaluation strategy. Forest Ecol Manag 5890: 1-19.

Gottofrey, J., Borg, K., and Jasmin, S. (1988) Effect of postassium ethylxanthate and sodium diethyidithiocarbamate on the accumulation and deposition of nickel in the brown trout (Salmo trutta). Pharmacol. Toxicol. 63: 46-51.

Graff, L., Muller, G., and Burnel, D. (1995) In vitro and in vivo evaluation of potential aluminum chelators. Vet. Hum. Toxicol. 88: 271-292.

Hamilton, W. A. (2003) Microbially influenced corrosion as a model system for the study of metal microbe interactions: a unifying electron transfer hypothesis. Biofouling 19: 65-76.

Harrison, J. J., Ceri, H., Stremick, C., and Turner, R. J. (2004) Biofilm susceptibility to metal toxicity. Environ. Microbiol. (in press).

Hernandez, L., Probst, A., JProbst, J. L., and Ulrich, E. (2003) Heavy metal distribution in some French forest soils: evidence for atmospheric contamination. Science Total Environ 312: 195-219.

Keren, I., Kaldalu, N., Spoering, A., and Lewis, K. (2004) Pesister cells and tolerance to antimicrobials. FEMS Microbiol. Letters 230: 13-18.

Korch, S. B., Henderson, T. A., and Hill, T. M. (2003) Characterization of the hipA7 allele of Escherichia coli and evidence that high persistence is governed by (p)ppGpp synthesis. Mol Microbiol 50: 1199-1213.

Lewis, K. (2001) Riddle of biofilm resistance. Antimicrob Agents Chemother 45: 999-1007.

Mages, M., Ovari, M., Tumpling, W., and Kropfl, K. (2004) Biofilms as bio-indicator for polluted waters? Total reflection X-ray fluorescence analysis of biofilms of the Tisza river (Hungary). Anal. Bioanal. Chem. 378: 1095-1101.

Morck, D. W., Lam, K., McKay, S. G., Olson, M. E., Prosser, B., Ellis, B. D. et al. (1994) Comparative evaluation of fleroxacin, ampicillin, trimethoprim-sulfamethoxazole, and gentamicin as treatments of catheter associated urinary tract infections in a rabbit model. Am J Med 94: 23S-30S.

Nies, D. H. (2003) Efflux-mediated heavy metal resistance in prokaryotes. FEMS Microbiol Rev 27: 313-339.

Olson, M. E., Ceri, H., Morck, D. W., Buret, A. G., and Read, R. R. (2002) Biofilm bacteria: formation and comparative susceptibility to antibiotics. Can. J. Vet. Res. 66: 86-92.

Silver, S. (1998) Genes for all metals—a bacterial view of the Periodic Table: The 1996 Thom Award Lecture. J. Ind. Microbiol. Biotech. 20: 1-12.

Spoering, A., and Lewis, K. (2001) Biofilm and planktonic cells of Pseudomonas aeruginosa have similar resistance to killing by antimicrobials. J. Bacteriol. 183: 6746-6751.

Stewart, P. S. (2002) Mechanisms of antibiotic resistance in bacterial biofilms. Int J Med Microbiol 292: 107-113.

Stewart, P. S. (2003) Diffusion in biofilms. J Bacteriol 185: 1485-1491.

Stewart, P. S., Rayner, J., Roe, F., and Rees, W. M. (2001) Biofilm penetration and disinfection efficacy of alkaline hypochlorite and chlorosulfamates. J Appl Microbiol 91: 525-532.

Sutherland, I. W. (2001) The biofilm matrix—an immobilized but dynamic microbial environment. Trends Microbiol 9.

Taylor, D. E. (1999) Bacterial tellurite resistance. Trends Microbiol 7: 111-115.

Teitzel, G. M., and Parsek, M. R. (2003) Heavy metal resistance of biofilm and planktonic Pseudomonas aeruginosa. Appl. Environ. Microbiol. 69: 2313-2320.

Turner, R. J., Weiner, J. H., and Taylor, D. E. (1999) Tellurite-mediated thiol oxidation in Escherichia coli. Microbiology 145 (Pt 9): 2549-2557.

Walters III, M. C., Roe, F., Bugnicourt, A., Franklin, M. J., and Stewart, P. S. (2003) Contributions of antibiotic penetration, oxygen limitation, and low metabolic activity to tolerance of Pseudomonas aeruginosa biofilms to ciprofloxacin and tobramycin. Antimicrob Agents Chemother 47: 317-323.

Whitchurch, C. B., Tolker-Neilsen, T., Ragas, P. C., and Mattick, J. S. (2002) Extracellular DNA required for bacterial biofilm formation. Science 295: 1487.

Wozniak, D. J., Wycoff, T. O., Starkey, M., Keyser, R., Azadi, P., O'Toole, G. A., and Parsek, M. R. (2003) Alginate is not a significant component of the extracellular polysaccharide matrix of PA14 and PAO1 Pseudomonas aeruginosa biofilms. Proc. Natl. Acad. Sci. USA 100: 7907-7912.

Agar, N. S., Mahoney, J. R., and Easton, J. W. (1991) Hemolytic and microbicidal actions of diethlydithiocarbamic acid. Biochem. Pharmacol. 41: 985-993.

Aslund, F., Zheng, M., Beckwith, J., and Storiz, G. (1999) Regulation of the OxyR transcription factor by hydrogen peroxide and the cellular thiol-disulfide status. Proc. Natl. Acad. Sci. 96: 6161-6165.

Ceri, H., Olson, M. E., Stremick, C., Read, R. R., Morck, D. W., and Buret, A. G. (1999) The Calgary Biofilm Device: New technology for rapid determination of antibiotic susceptibilities in bacterial biofilms. J. Clin. Microbiol. 37: 1771-1776.

Ceri, H., Olson, M. E., Morck, D. W., Storey, D., Read, R. R., Buret, A. G., and Olson, B. (2001) The MBEC assay system: Multiple equivalent biofilms for antibiotic and biocide susceptibility testing. Methods Enzymol. 337: 377-384.

Codony, F., Domenico, P., and Mas, J. (2003) Assessment of bismuth thiols and conventional disinfectants on drinking water biofilms. J Appl Microbiol 95: 288-293.

Costerton, J. W., Stewart, P. S., and Greenberg, E. P. (1999) Bacterial biofilms: a common cause of persistent infections. Science 284: 1318-1322.

de Vincente, A., Aviles, M., Codina, J. C., Borrego, J. J., and Romero, P. (1990) Resistance to antibiotics and heavy metals of Pseudomonas aeruginosa isolated from natural waters. J. Appl. Bacteriol. 68: 625-632.

DeBeer, D., Stoodley, P., Roe, F., and Lewandowski, Z. (1994) Effects of biofilm structure on oxygen distribution and mass transport. Biotechnol. Bioeng. 43: 1131-1138.

Diurdjevic, P., and Djokic, D. (1996) Protein interactions with bivalent tin. 1. Hydrolysis and complexation of tin(II) with glycine. J. Inorganic Biochem. 62: 17-29.

Donlan, R. M., and Costerton, J. W. (2002) Biofilms: survival mechanisms of clinically relevant microorganisms. Clin. Microbiol. Rev. 15: 167-193.

Geslin, C., Llanos, J., Prieur, D., and Jeanthon, C. (2001) The manganese and iron superoxide dismutases protect Escherichia coli from heavy metal toxicity. Res. Microbiol. 152: 901-905.

Gottofrey, J., Borg, K., and Jasmin, S. (1988) Effect of postassium ethylxanthate and sodium diethyldithiocarbamate on the accumulation and deposition of nickel in the brown trout (Salmo trutta). Pharmacol. Toxicol. 63: 46-51.

Graff, L., Muller, G., and Burnel, D. (1995) In vitro and in vivo evaluation of potential aluminum chelators. Vet. Hum. Toxicol. 88: 271-292.

Lawrence, J. R., Korber, D. R., Hoyle, B. D., Costerton, J. W., and Caldwell, D. E. (1991) Optical sectioning of microbial biofilms. J. Bacteriol. 173: 6558-6567.

Lewis, K. (2001) Riddle of biofilm resistance. Antimicrob Agents Chemother 45: 999-1007.

Missy, P., Lanhers, M. C., Grignon, Y., Joyeux, M., and Burnel, D. (2000) In vitro and in vivo studies on chelation of manganese. Hum. Exper. Toxicol. 19: 448-456.

Morck, D. W., Lam, K., McKay, S. G., Olson, M. E., Prosser, B., Ellis, B. D. et al. (1994) Comparative evaluation of fleroxacin, ampicillin, trimethoprim-sulfamethoxazole, and gentamicin as treatments of catheter associated urinary tract infections in a rabbit model. Am J Med 94: 23S-30S.

Nies, D. H. (1999) Microbial heavy-metal resistance. Appl. Microbiol. Biotechnol. 51: 730-750.

Olson, M. E., Ceri, H., Morck, D. W., Buret, A. G., and Read, R. R. (2002) Biofilm bacteria: formation and comparative susceptibility to antibiotics. Can. J. Vet. Res. 66: 86-92.

Rawlings, D. E. (2002) Heavy metal mining using microbes. Ann. Rev. Microbiol. 56: 65-91.

Razatos, A., Ong, Y. L., Sharma, M. M., and Georgiou, G. G. (1998) Molecular determinants of bacterial adhesion monitored by atomic force microscopy. Proc. Natl. Acad. Sci. USA 95:11059-11064.

Russel, A. D., Ahonkhai, I., and Rogers, D. T. (1979) Microbiological applications of the inactivation of antibiotics and other antimicrobial agents. J. Appl. Bacteriol. 46: 207-245.

Silver, S. (1998) Genes for all metals—a bacterial view of the Periodic Table: The 1996 Thom Award Lecture. J. Ind. Microbiol. Biotech. 20: 1-12.

Sutherland, I. W. (2001) The biofilm matrix—an immobilized but dynamic microbial environment. Trends Microbiol 9.

Taylor, D. E. (1999) Bacterial tellurite resistance. Trends Microbiol 7: 111-115.

Teitzel, G. M., and Parsek, M. R. (2003) Heavy metal resistance of biofilm and planktonic Pseudomonas aeruginosa. Appl. Environ. Microbiol. 69: 2313-2320.

Turner, R. J. (2001) Tellurite toxicity and resistance in Gram-negative bacteria. Recent Res. Devel. Microbiol. 5: 69-77.

Turner, R. J., Weiner, J., and Taylor, D. E. (1999) Tellurite mediated thiol oxidation in Escherichia coli. Microbiol. 145: 2549-2557.

Valls, M., and de Lorenzo, V. (2002) Exploiting the genetic and biochemical capcities of bacteria for the remediation of heavy metal pollution. FEMS Microbiol. Rev. 26: 327-338.

Whitchurch, C. B., Tolker-Neilsen, T., Ragas, P. C., and Mattick, J. S. (2002) Extracellular DNA required for bacterial biofilm formation. Science 295: 1487.

Wozniak, D. J., Wycoff, T. O., Starkey, M., Keyser, R., Azadi, P., O'Toole, G. A., and Parsek, M. R. (2003) Alginate is not a significant component of the extracellular polysaccharide matrix of PA14 and PAO1 Pseudomonas aeruginosa biofilms. Proc. Natl. Acad. Sci. USA 100: 7907-7912.

Almerich J M, Cabedo B, Ortola J C, Poblet J. Influence of alcohol in mouthwashes containing triclosan and zinc: an experimental gingivitis study. J Clin Periodontol. 2005 June; 32(6):539-44.

Giertsen E. Effects of mouthrinses with triclosan, zinc ions, copolymer, and sodium lauryl sulphate combined with fluoride on acid formation by dental plaque in vivo. Caries Res. 2004 September-October; 38(5):430-5.

Adams S E, Theobald A J, Jones N M, Barding M G, Cox T F, Mendez A, Chesters D M, Gilliam D G, Hall C, Holt J. The effect of a toothpaste containing 2% zinc citrate and 0.3% Triclosan on bacterial viability and plaque growth in vivo compared to a toothpaste containing 0.3% Triclosan and 2% copolymer.

Int Dent J. 2003 December; 53(6 Suppl 1):398-403.

Although the present invention has been described in terms of particular preferred embodiments, it is not limited to those embodiments. Alternative embodiments, examples, and modifications which would still be encompassed by the invention may be made by those skilled in the art, particularly in light of the foregoing teachings.

TABLE 1
Bactericidal concentrations of metal ions required to eradicate
Pseudomonas aeruginosa ATCC 27853 planktonic and biofilm cultures
at different exposure times in minimal media.

| Periodic | Metal | Exposure | MIC | MBC₁₀₀ | MBEC | Fold |
|---|---|---|---|---|---|---|
| group | ion | time (h)¹ | (mM) | (mM) | (mM) | Tolerance² |
| 8B | Co²⁺ | 2 to 6 | 2.0 ± 0.8 | 139 ± 0 | ≧278 | 2.0 |
| | | 8 | | 104 ± 40 | 139 ± 0 | 1.3 |
| | | 10 | | 174 ± 70* | 209 ± 80* | 1.2 |
| | | 27 | | 114 ± 44* | 116 ± 36* | 1.0 |
| | Ni²⁺ | 2 to 27 | 0.60 ± 0.21 | >140 | >140 | na |
| 1B | Cu²⁺ | 2 | 3.8 ± 1.9 | 20 ± 8 | ≧258 | 13 |
| | | 4 | | 32 ± 0 | 64 ± 45 | 2.0 |
| | | 6 | | 21 ± 14 | 36 ± 20 | 1.7 |
| | | 8 to 10 | | 16 ± 0 | 32 ± 0 | 2.0 |
| | | 27 | | 19 ± 11 | 21 ± 11 | 1.1 |
| 2B | Zn²⁺ | 2 to 8 | 9.5 ± 3.3 | >125 | >125 | na |
| | | 10 | | 109 ± 31* | ≧256 | 2.3 |
| | | 27 | | 102 ± 47* | 102 ± 47* | 1.0 |
| 3A | Al³⁺ | 2 to 4 | 7.8 ± 2.3 | 24 ± 9 | ≧607 | 25 |
| | | 6 | | 19 ± 0 | 322 ± 328 | 17 |
| | | 8 | | 19 ± 0 | 4.2 ± 3.6 | 0.2 |
| | | 10 | | 19 ± 0 | 9.5 ± 0 | 0.5 |
| | | 27 | | 33 ± 9 | 22 ± 7 | 0.7 |
| 4A | Pb²⁺ | 2 to 4 | 1.2 ± 0 | 20 ± 0 | ≧79 | 4.0 |
| | | 6 | | 30 ± 11 | ≧79 | 3.0 |
| | | 8 | | 12 ± 5 | 59 ± 23* | 4.9 |
| | | 10 | | 20 ± 0 | 59 ± 23* | 3.0 |
| | | 27 | | 16 ± 6 | 26 ± 15 | 1.6 |

na indicates a measurement that is not applicable
bold indicates the fold tolerance at 27 h of exposure
*indicates that the bacterial culture was killed at the threshold of the maximum - concentration of metal ion used in this study
¹all cultures were tested at exposure time intervals of 2, 4, 6, 8, 10 and 27 hours
²the fold tolerance, given the sensitivity of the assay on a log₂ scale, is equal to the ratio of the means of MBEC:MBC₁₀₀

TABLE 2
Susceptibility of Pseudomonas aeruginosa ATCC 27853 to
metal ions with 2 or 27 h of exposure in rich media.

| Periodic | Metal | Exposure | MIC | MBC₁₀₀ | MBEC | Fold |
|---|---|---|---|---|---|---|
| group | ion | time (h) | (mM) | (mM) | (mM) | Tolerance¹ |
| 8B | Co²⁺ | 2 | 7.6 ± 2.2 | 104 ± 40* | ≧280 | 2.7 |
| | | 27 | | 140 ± 0 | ≧280 | 2.0 |
| | Ni²⁺ | 2 or 27 | 17 ± 0 | >140 | >140 | na |
| 1B | Cu²⁺ | 2 | 12 ± 5 | 16 ± 0 | 72 ± 40 | 4.5 |
| | | 27 | | 16 ± 0 | 16 ± 0 | 1.0 |
| 2B | Zn²⁺ | 2 or 27 | 78 ± 31 | >125 | >125 | na |
| 3A | Al³⁺ | 2 | 9.5 ± 0 | 189 ± 76 | ≧607 | 3.2 |
| | | 27 | | 21 ± 12 | 24 ± 9 | 1.1 |
| 4A | Pb²⁺ | 2 | 12 ± 5 | >40 | >40 | na |
| | | 27 | | 4 79 | 59 ± 23* | 0.7 |

na indicates a measurement that is not applicable
bold indicates the fold tolerance at 27 h of exposure
*indicates that the bacterial culture was killed at the threshold of the maximum concentration of metal ion used in this study
¹the fold tolerance, given the sensitivity of the assay on a log₂ scale, is equal to the ratio of the means of MBEC:MBC₁₀₀

TABLE 3
Relative levels of resistance of Escherichia coli JM109 planktonic
and biofilm bacteria to antibiotics (all values are in μg/ml)

| Antibiotic | MIC | MBC | MBEC |
|---|---|---|---|
| Ampicillin | 4 ± 0 | 64 ± 0 | 1024 ± 0 |
| Cefazolin | 3.5 ± 1 | 64 ± 0 | 128 ± 0 |
| Chloramphenicol | 3.5 ± 1 | 128 ± 0 | >256 |
| Pipperacillin | 4 ± 0 | 16 ± 0 | 32 ± 0 |
| Tobramycin | 4 ± 0 | 8 ± 0 | 16 ± 0 |

TABLE 4
Relative levels of resistance of Staphylococcus aureus
ATCC 29213 planktonic and biofilm bacteria to antibiotics
(all values are in μg/ml)

| Antibiotic | MIC | MBC | MBEC |
|---|---|---|---|
| Chloramphenicol | 80 ± 32 | 1024 ± 0 | >1024 |
| Ciprofloxacin | <2 | 16 ± 0 | 922 ± 229 |
| Gentamicin | <2 | 4 ± 0 | 3.5 ± 1 |

TABLE 5
Relative levels of resistance of Pseudomonas aeruginosa
ATCC 27853 planktonic and biofilm bacteria to antibiotics
(all values are in μg/ml)

| Antibiotic | MIC | MBC | MBEC |
|---|---|---|---|
| Amikacin | 32 ± 0 | 224 ± 64 | >512 |
| Ampicillin | >512 | >512 | >512 |
| Cefazolin | >512 | >512 | >512 |
| Chloramphenicol | >512 | >512 | >512 |
| Ciprofloxacin | 1 ± 0 | 10 ± 4 | >128 |
| Gentamicin | 10 ± 4 | 28 ± 8 | >1024 |
| Tobramycin | 14 ± 4 | 28 ± 8 | 112 ± 32 |

TABLE 6
Relative levels of resistance of Escherichia coli JM109 planktonic
and biofilm bacteria to metal toxicity (all values are in mM)

| Metal | Group | n | MIC | MBC | MBEC |
|---|---|---|---|---|---|
| CrO₄²⁻ | VI B | 4 | 0.15 ± 0 | 0.30 ± 0 | 0.30 ± 0 |
| MoO₄²⁻ | | 5 | >102 | >102 | >102 |
| WO₄²⁻ | | 6 | >66 | >66 | >66 |
| Mn²⁺ | VII B | 4 | 37 ± 0 | 199 ± 86 | 199 ± 86 |
| Ni²⁺ | VIII B | 4 | 8.7 ± 0 | 18 ± 0 | 18 ± 0 |
| Cu²⁺ | I B | 4 | 4.5 ± 1.4 | 15 ± 3 | 13 ± 4 |
| Ag⁺ | | 5 | 0.06 ± 0.02 | 0.09 ± 0.04 | 0.07 ± 0.02 |
| Zn²⁺ | II B | 4 | 2.2 ± 0.7 | 31 ± 0 | 31 ± 0 |
| Cd²⁺ | | 5 | 1.1 ± 0 | 2.3 ± 0 | 2.3 ± 0 |
| Hg²⁺ | | 6 | 0.07 ± 0.05 | 0.07 ± 0.05 | 0.07 ± 0.05 |
| Al³⁺ | III A | 3 | * | 19 ± 0 | 19 ± 0 |
| Sn²⁺ | IV A | 5 | * | 17 ± 0 | 17 ± 0 |
| AsO₂⁻ | V A | 4 | 2.4 ± 0 | 77 ± 0 | 77 ± 0 |
| AsO₄²⁻ | | 4 | 7.4 ± 0 | >60 | >60 |
| SeO₃²⁻ | VI A | 4 | 8.1 ± 0 | 8.1 ± 0 | 8.1 ± 0 |
| TeO₃²⁻ | | 5 | 0.006 ± | 0.016 ± | 0.014 ± |
| | | | 0.004 | 0.007 | 0.009 |
| TeO₄²⁻ | | 5 | 0.06 ± 0.02 | 0.42 ± 0.17 | 0.42 ± 0.17 |

bold denotes the three most toxic metal compounds to Escherichia coli JM109
n denotes the principal quantum number
* denotes an assay where MIC could not be accurately determined due to precipitation in the wells

TABLE 7
Relative levels of resistance of Staphylococcus aureus
ATCC 29213 planktonic and biofilm bacteria to
metal toxicity (all values are in mM)

| Metal | Group | n | MIC | MBC | MBEC |
|---|---|---|---|---|---|
| CrO₄²⁻ | VI B | 4 | 2.4 ± 0 | 2.4 ± 0 | 2.1 ± 0.6 |
| MoO₄²⁻ | | 5 | >102 | >102 | >102 |
| WO₄²⁻ | | 6 | >66 | >66 | >66 |
| Mn²⁺ | VII B | 4 | 12 ± 5 | >149 | >149 |
| Ni²⁺ | VIII B | 4 | 4.4 ± 0 | >140 | >140 |
| Cu²⁺ | I B | 4 | 2.0 ± 0 | 2.0 ± 0 | 2.0 ± 0 |
| Ag⁺ | | 5 | 0.30 ± 0 | 9.5 ± 0 | >9.5 |
| Zn²⁺ | II B | 4 | 2.0 ± 0 | >125 | >125 |
| Cd²⁺ | | 5 | 0.25 ± 0.07 | 18.2 ± 0 | 15.9 ± 4.6 |
| Hg²⁺ | | 6 | 0.020 ± | 0.080 ± 0 | 0.080 ± 0 |
| | | | 0.008 | | |
| Al³⁺ | III A | 3 | 76 ± 0 | >304 | >304 |
| Sn²⁺ | IV A | 5 | 8.6 ± 0 | 17.3 ± 0 | 17.3 ± 0 |
| AsO₂⁻ | V A | 4 | 9.6 ± 0 | >77 | >77 |
| AsO₄²⁻ | | 4 | 15 ± 0 | >59 | >59 |
| SeO₃²⁻ | VI A | 4 | 16 ± 0 | 16 ± 0 | 16 ± 0 |
| TeO₃²⁻ | | 5 | 0.18 ± 0 | >0.73 | 0.73 ± 0 |
| TeO₄²⁻ | | 5 | 0.67 ± 0 | >1.3 | 1.3 ± 0.7 |

bold denotes the three most toxic metal compounds to Staphylococcus aureus ATCC 29213
n denotes the principal quantum number

TABLE 8
Relative levels of resistance of Pseudomonas aeruginosa
ATCC 27853 planktonic and biofilm bacteria to metal
toxicity (all values are in mM)

| Metal | Group | n | MIC | MBC | MBEC |
|---|---|---|---|---|---|
| CrO₄²⁻ | VI B | 4 | 4.1 ± 1.2 | 3.6 ± 1.4 | 3.6 ± 1.4 |
| MoO₄²⁻ | | 5 | >102 | >102 | >102 |
| WO₄²⁻ | | 6 | >66 | >66 | >66 |
| Mn²⁺ | VII B | 4 | >149 | >149 | >149 |
| Ni²⁺ | VIII B | 4 | 18 ± 0 | >140 | >140 |
| Cu²⁺ | I B | 4 | 12 ± 5 | 14 ± 4.0 | 14 ± 4.0 |
| Ag⁺ | | 5 | 0.30 ± 0 | 0.30 ± 0 | 0.40 ± 0.17 |
| Zn²⁺ | II B | 4 | 78 ± 31 | >125 | >125 |
| Cd²⁺ | | 5 | 4.6 ± 0 | 36 ± 0 | 36 ± 0 |
| Hg²⁺ | | 6 | 0.38 ± 0.14 | 0.53 ± 0.39 | 0.43 ± 0.16 |
| Al³⁺ | III A | 3 | 9.5 ± 0 | 21 ± 12 | 21 ± 7 |
| Sn²⁺ | IV A | 5 | 17 ± 0 | 22 ± 9 | 17 ± 0 |
| AsO₂⁻ | V A | 4 | >77 | >77 | >77 |
| AsO₄²⁻ | | 4 | >59 | >59 | >59 |
| SeO₃²⁻ | VI A | 4 | 28 ± 8 | 28 ± 8 | 28 ± 8 |
| TeO₃²⁻ | | 5 | 0.73 ± 0 | 5.1 ± 0 | 4.4 ± 1.7 |
| TeO₄²⁻ | | 5 | >1.3 | >1.3 | >1.3 |

bold denotes the three most toxic metal compounds to Pseudomonas aeruginosa ATCC 27853
n denotes the principal quantum number

TABLE 9
Resistance of Pseudomonas aeruginosa biofilms to metal
and antibiotic combinations (all values in μg/ml)

| | | [metal] in | | | |
|---|---|---|---|---|---|
| | | combination | | | |
| | Heavy | assay | MIC | MBC | MBEC |
| Antibiotic | metal | (μg/ml) | (μg/ml) | (μg/ml) | (μg/ml) |
| Amikacin | None | N/A | 32 | 256 | >512 |
| Ciprofloxacin | None | N/A | 1 | 8 | >128 |
| Gentamicin | None | N/A | 8 | 32 | >1024 |
| Amikacin | Cu²⁺ | 200 | 0.125* | >64 | >64 |
| Ciprofloxacin | Cu²⁺ | 200 | 4 | 8 | 16** |
| Gentamicin | Zn²⁺ | 500 | 64 | 128 | >128 |
| Ciprofloxacin | Zn²⁺ | 500 | 0.25-1.0 | 32 | >64 |
| None | Cu²⁺ | N/A | 512-1024 | 1024 | 1024 |
| None | Zn²⁺ | N/A | 4096 | >8192 | >8192 |

1. *The MIC for amikacin in the presence of 200 μg/ml Cu²⁺ is 256 times less than the MIC for amikacin alone
2. **The MBEC for ciprofloxacin in the presence of 200 μg/ml Cu²⁺ is at least 16 times less than the MBEC for ciprofloxacin alone

### Notes on Methods

Cells were grown to a mean density of 6.0×10⁶ cfu/peg in LB+B1 media.
No neutralizing agents were employed as the quantity of metal used in combination assays was less than ½ of the MIC for the metal alone.
All data are median values based on 4 replicates

1. A method of treating biofilms comprising contacting a biofilm with a composition comprising a heavy metal, and exposing the biofilm to the heavy metal for greater than about four hours.

2. The method of claim 1 wherein the biofilm is one or more microorganisms selected from the group consisting of gram-positive bacteria, gram-negative bacteria, fungi, algae, and archaebacteria.

3. (canceled)

4. (canceled)

5. (canceled)

6. (canceled)

7. (canceled)

8. (canceled)

9. (canceled)

10. (canceled)

11. The method of claim 1 wherein the heavy metal is one or more heavy metals selected from the group consisting of metal cations, metals oxyanions, and metalloid oxyanions.

12. (canceled)

13. (The method of claim 11 wherein the metal cations is one or more metal cations selected from the group consisting of Mn2+, Co2+ (heavy metal), Ni2+ (heavy metal), Cu2+ (heavy metal), Zn2+ (heavy metal), Al3+, Ag+ (heavy metal), Hg2+ (heavy metal), Pb2+ (heavy metal), Cd+ (heavy metal), and Sn2+ (heavy metal).

14. (canceled)

15. (canceled)

16. (canceled)

17. (canceled)

18. The method of claim 1 wherein the exposure period is greater than about four hours and any incremental time period greater than about four hours.

19. The method of claim 18 wherein the exposure period is from about four to about thirty six hours and any incremental time period therein.

20. (canceled)

21. (canceled)

22. (canceled)

23. (canceled)

24. (canceled)

25. (canceled)

26. (canceled)

27. (canceled)

28. The method of claim 1 further comprising exposing the biofilm to an antibiotic, sequentially or in combination with the heavy metal.

29. A method of treating biofilms comprising contacting a biofilm in an environment, wherein said environment comprised human, animal, plant, and industrial.

30. (canceled)

31. (canceled)

32. (canceled)

33. (canceled)

34. (canceled)

35. (canceled)

36. (canceled)

37. (canceled)

38. The method of claim 1 further comprising exposing the biofilm to an active agent, sequentially or in combination with the heavy metal, wherein said active agent is effective against the biofilm.

39. The method of claim 38 wherein the active agent comprises one or more agents from the group consisting of a biocide, a fungicide, an antibiotic, a polycide, and an anti-microbial agent.
